(19) United States
(12) Patent Application Publication
(10) Pub. No.: US 2024/0258532 A1
(43) Pub. Date: Aug. 1, 2024

(54) INTERTWINED ELECTRODE NETWORK

(71) Applicant: INNOVASION LABS PINC, INC., San Diego, CA (US)

(72) Inventor: Inac ORTAC, San Diego, CA (US)

(21) Appl. No.: 18/564,569

(22) PCT Filed: May 31, 2022
(86) PCT No.: PCT/US22/31671

§ 371 Date: Nov. 27, 2023

Related U.S. Application Data
(60) Provisional application No. 63/194,615, filed on May 28, 2021.
(60) Provisional application No. 63/344,010, filed on May 19, 2022.
(60) Provisional application No. 63/335,690, filed on Apr. 27, 2022.
(60) Provisional application No. 63/334,661, filed on Apr. 25, 2022.

(51) Int. Cl. H01M 4/74; H01G 11/00; H01M 4/02; H01M 4/66

(52) U.S. Cl. CPC H01M 4/74; H01G 11/00; H01M 4/663; H01M 4/667; H01M 2004/021

(57) ABSTRACT

A nano-device comprising: a mesh of carbon nanotubes; and a nanoparticle-nanowire-network (NNN) embedded within the mesh of conductive nanostructures, wherein the NNN comprises a plurality of nanoparticles connected by a plurality of nanostructures (nanowires).

### TECHNICAL FIELD

The invention relates to nano-energy devices and related methods.

### INTRODUCTION

The overall approach to building electronic components such as batteries and capacitors has not changed since their first invention around 18^{th} and 19^{th} century. FIG. 1 is a diagram 100 illustrating components of a current energy storage technology (e.g., a battery). The battery may include an anode 101, a cathode 102, and an electrolyte material 103. FIG. 2 is a diagram 200 illustrates components of a lithium-ion battery in accordance with current energy storage technologies. Diagram 210 illustrates a first discharging operation and diagram 220 illustrates a charging operation of the lithium-ion battery. The lithium-ion battery may include a cathode terminal 211 (e.g., an aluminum current collector), a separator 212, an electrolyte solution 213, an anode terminal 214 (e.g., a copper current collector). The lithium-ion battery may further include a lithium metal oxide material 217 and a lithium metal carbon material 216 that may be associated with a set of electrons 215 and lithium ions 218 that may be exchanged (released or incorporated).

In particular, for the case of capacitors and batteries, the improvements have mostly focused on the use of different materials for the electrodes, or anodes and cathodes. In particular, the overall structure of capacitors involves two electrodes separated by a dielectric material. For batteries, a cathode and anode may be separated by a gap filled with an electrolyte material. There is an additional salt bridge that allows controlled diffusion of ions and often a separator for prevention of short circuits. The improvement of batteries has typically involved improving the energy density of the anode and cathode. Other developments include improvement of electrolyte material and improvement of chemistry mainly focused on the type of charge carrying ions. For capacitors, charge capacity of electrodes has been improved and the distance between the electrodes has been reduced to improve the electric field produced in between electrodes. Super capacitors (sometimes referred to as ultra-capacitors) have been developed, which allow the generation of an electric field between the electrode and a double layer in solution, which essentially reduces the effective distance dramatically.

However, these approaches are not sufficient to address the need for higher energy and/or power capacity. Lithium has the highest electrochemical potential of all metals and highest energy density of all potential battery materials. However, electrochemical plating of lithium is known to generate dendrites that: reduce the efficiency, can short the battery, prevent safe operation of the cell, and can even cause a violent explosion.

Current solutions to this problem include attempts at slowing down the recharging rate, inclusion of additives to the electrolyte, and addition of mechanisms to turn off cells when they exceed certain temperatures. These all increase the size, weight, and complexity of the energy devices, e.g., batteries and capacitors, and thus reduces their practicality.

In the case of batteries, current approaches use anodes and cathodes that have a very high surface area due to their porosity and thus, high energy content. However, the ions still need to pass through electrolyte medium with limited diffusion and have separators that aim to prevent potential shorts between the anode and cathode. If the ions accumulate too fast and if they don't have time to settle and find allocated spots on the counter electrode, certain unwanted effects are observed, such as, the formation of dendrites in the case of lithium. These dendrites are structures that stick out of the surface and can short the anode and cathode, causing hazards such as, an exothermic chain reaction resulting in an explosion. Although the surface areas of anodes and cathodes have improved over time, the electrolyte has not been improved, thus limiting the overall performance of the battery.

In the case of capacitors, having a very porous electrode structure (which is typically the main area for improvement) does not help much because what matters most is the distance between the two electrodes. However, having an essentially thicker electrode would end up producing a longer distance between the two extremes of the electrodes, thereby reducing the electric field amplitude and reducing the amount of energy stored within the electric field.

In short, for energy storage very high surface areas of electrodes are important; charge and discharge rates must be fast; safety is a big concern (i.e. Samsung Galaxy Note 7 incident); current batteries have very high energy density but slow charge/discharge; lithium ion batteries pose fire hazards; lithium ion batteries have high surface area cathodes, however, they need to limit the electrolyte ionic fluid flow because of fire hazard; capacitors have much faster charge and discharge but have low energy density; ultracapacitors have much higher energy density compared to capacitors but low voltage is a limitation because of a double layer, therefore they cannot reach a battery's energy capacity; and both ultracapacitors and lithium ion batteries have voltage limits although high voltage is always desirable for storage applications.

Accordingly, new devices, as well as methods of using and methods of making energy devices are needed.

### SUMMARY

In some embodiments, a nano-device is provided, the nano-device my include:
a mesh of conductive nanostructures (nanowires or nanotubes) in electrical contact; and
a nanoparticle network embedded within the mesh of conductive nanostructures (nanowires), wherein the nanoparticle network comprises a plurality of nanoparticles in electrical contact.

In some embodiments, the conductive nanowires comprise carbon nanotubes and the nanoparticle network further comprises a plurality of nanowires providing the electrical contact between the plurality of nanoparticles. Each of the plurality of nanoparticles, in some embodiments, may be coated with an insulating layer, and each of the plurality of nanowires comprises a phosphate backbone that insulates a central axis of the nanowire. The nano-device may include, in some embodiments, a first terminal and a second terminal.

The mesh and nanoparticle network, in some embodiments, are positioned between the two first terminal and the second terminal. In some embodiments, the first terminal and the second terminal are on a same side of the nano-device. The nano-device, in some embodiments, may be one of a battery and/or a capacitor. In some embodiments, the nanoparticle network is electrically connected to the first terminal by a set of nanowires in the nanoparticle network and/or the mesh is electrically connected to the second terminal by a subset of the nanowires. The nano-device, in some embodiments, the mesh is electrically connected to both of the first terminal and the second terminal by subsets of the nanowires.

In some embodiments, each of the plurality of nanoparticles is coated with an insulating layer, and each of the plurality of nanowires comprises a phosphate backbone that insulates a central axis of the nanowire. Each of the nanowires, in some embodiments, has a diameter in the range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the carbon nanotubes have diameters selected from no greater than: 900, 800, 700, 600, 500, 400, 300, 200, 100, 90, 80, 70, 60, 50, 40, 30, 25, 20, 15, 10, 9, 8, 7, 6, 5, 4, 3, 2 or 1 nm. In some embodiments, each of the nanowires has a length in the range selected from the group consisting of between: 0.01-500, 0.02-400, 0.03-300, 0.04-250, 0.05-200, 0.06-150, 0.07-125, 0.08-100, 0.09-90, 0.1-90, 0.1-80, 0.1-70, 0.1-60, 0.1-50, 0.1-40, 0.2-30; 0.3-20; 0.4-15; 0.5-10; 0.7-5; 0.8-4; 0.9-3, 1-3 microns; or the carbon nanotubes have lengths selected from no greater than: 900, 800, 700, 600, 500, 400, 300, 200, 100, 90, 80, 70, 60, 50, 40, 30, 25, 20, 15, 10, 9, 8, 7, 6, 5, 4, 3, 2, or 1 microns. The plurality of nanoparticles, in some embodiments, has a diameter may be in the range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the diameter of each of the nanoparticles is selected from the group consisting of no greater than: 900; 800, 700, 600, 500, 450, 400, 350, 300, 275, 250, 225, 200, 175, 150, 125, 100, 90, 80, 70, 60, 50, 45, 40, 35, 30 25, 20, 19, 18, 17, 16, 15, 14, 13, 12, 11, 10, 9, 8, 7, 6, 5, 4, 3, 2 and no greater than 1 nm.

In some embodiments, the nano-device may include an electrolyte material comprising a medium for a transfer of ions between the mesh of conductive nanostructures (nanowires) and the nanoparticle network. The electrolyte material, in some embodiments, comprises a solvent and a solute. In some embodiments, the electrolyte material comprises a solid state electrolyte material, the solid state electrolyte material being a conductor for the ions and an insulator for electrons.

The nanowires, in some embodiments, may include silicon-based nanowires or a carbon-based nanowire. The nanoparticle network (e.g., the nanoparticles) may include a material selected from the group consisting of one or more of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron(III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese(IV) Oxide, Nickel Hydroxide, Silver Chromate, Silver Oxide, and/or Vanadium Pentoxide.

The nano-device, in some embodiments, may include a non-conductive separator layer may be interposed between the mesh of conductive nanostructures (nanowires) and the nanoparticle network. The non-conductive separator layer, in some embodiments, may be deposited on a surface of the mesh of conductive nanostructures (nanowires). In some embodiments, the non-conductive separator layer is a polymer layer.

A charging operation of the nano-device (e.g., a composite-device) includes one of a multidirectional flow of ions from the nanoparticle network to the mesh of conductive nanostructures (nanowires) or an omnidirectional flow of ions from the nanoparticle network to the mesh of conductive nanostructures (nanowires). An average ionic diffusion distance for ions diffusing from the nanoparticle network to the mesh of conductive nanostructures (nanowires), in some embodiments, may be less than at least one of 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm. In some embodiments, the characteristic size of a network of interconnected empty volumes within the mesh of conductive nanostructures (nanowires) is less than at least one of 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm. The characteristic size of conductive nanoparticles in the nanoparticle network, in some embodiments, may be less than one of 90%, 80%, 70%, 60%, 50%, 40%, 30%, 20%, or 10% of the characteristic size of the network of interconnected empty volumes. The standard deviation of the size of conductive nanoparticles in the nanoparticle network, in some embodiments, may be one of 1%, 3%, 5%, 10%, 15%, 20%, 25%, 30%, 35%, 40%, 45%, or 50% of the characteristic size of the conductive nanoparticles in the nanoparticle network.

The nano-device, in some embodiments, may be capable of being charged from 10 percent to 90 percent in less than one of one hour, 45 minutes, 30 minutes, 10 minutes, 1 minute, 45 seconds, 30 seconds, 10 seconds, 5 seconds, 1 second, 0.1 second, 1×10⁻² seconds, 1×10⁻³ seconds, 1×10⁻⁴ seconds, 1×10⁻⁵ seconds, and/or 1×10⁻⁶ seconds. In some embodiments, the nano-device may be capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles before a breakdown. The breakdown may be an uncontrolled discharge of energy. The nano-device, in some embodiments, may be capable of being charged and discharged for at least one of 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, and/or 1×10⁹ cycles while achieving at least 50, 55, 60, 65, 70, 75, 80, 85, 90, and/or 95 percent of an initial charge.

In some embodiments, an average distance from any point within the nanoparticle network to a closest point within the mesh of conductive nanostructures (nanowires) is less than at least one of 100 μm, 50 μm, 10 μm, 1 μm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, or 1 nm. A ratio between a surface area of an interface between the nanoparticle network and the mesh of conductive nanostructures (nanowires) and a volume of the nano-device, in some embodiments, may be greater than 200 cm⁻¹, 500 cm⁻¹, 1000 cm⁻¹, 5000 cm⁻¹, 1×10⁴ cm⁻¹, 5×10⁴ cm⁻¹, 1×10⁵ cm⁻¹, 1×10⁶ cm⁻¹, 1×10⁷ cm⁻¹, 1×10⁸ cm⁻¹. In some embodiments, empty volumes of the mesh of conductive nanostructures (nanowires) may include one or more of 1%, 5%, 10%, 15%, 20%, 25%, 30%, 35%, 40%, 45%, or 50% unfilled volume after the conductive nanoparticles are embedded within the mesh of conductive nanostructures (nanowires). The unfilled volume, in some embodiments, accommodates expansion of the mesh of conductive nanostructures (nanowires) during a charging operation.

The gravimetric energy density of the nano-device (e.g., a composite-device), in some embodiments, may be greater than at least one of 300 Wh/Kg, 1000 Wh/Kg, 2000 Wh/Kg, 5000 Wh/Kg, 10×10³ Wh/Kg, and/or 20×10³ Wh/Kg. A power density of the composite-device, in some embodiments, may be greater than at least one of 300 W/Kg, 500 W/Kg, 1000 W/Kg, 2000 W/Kg, 3000 W/Kg, 4000 W/Kg, 5000 W/Kg, 6000 W/Kg, 7000 W/Kg, 8000 W/Kg, 9000 W/Kg, 10×10³ W/Kg, and/or 20×10³ W/Kg. In some embodiments, a volumetric energy density of the composite-device is greater than at least one of 5, 10, 15, 20, 30, 40, and/or 50 MJ/L.

In some embodiments, the mesh of conductive nanostructures (nanowires) comprises at least a first type of nanowire and a second additive component. The second additive component, in some embodiments, may be one of an additive nanoparticle increasing a conductivity of the mesh of conductive nanostructures (nanowires) or a binder increasing a structural integrity of the mesh of conductive nanostructures (nanowires). The nanoparticle network, in some embodiments, comprises at least a first cathode nanoparticle type and a second additive component. The second additive component, in some embodiments, may be one of an additive nanoparticle increasing a conductivity of the nanoparticle network or a binder increasing a structural integrity of the nanoparticle network.

In another embodiment, in lieu using a mesh of conductive nanostructures (e.g., conductive carbon nanotubes), also contemplated herein is the use of a porous conductive substrate capable of conducting or storing a charge, wherein said substrate comprises a plurality of pores,

In a particular embodiment of invention nano-devices, the porous conductive substrate is coated with, or comprises, a separator layer. In an additional embodiment, the porous conductive substrate comprises a non-conductive surface layer between the conductive surface layer and the nanoparticle-nanowire-network (NNN). In another embodiment, the nano-device comprises a first and second terminal, wherein the first terminal is attached to the porous conductive substrate and the second terminal is attached to the NNN. In a further embodiment, the terminals are part of a composite-device. In some embodiments, the composite-device is a composite-nanobattery or a composite nano-capacitor.

In yet another embodiment, in lieu using a mesh of conductive nanostructures (e.g., conductive nanotubes), also contemplated herein is the use of a continuous conductive substrate (CCS (OR PM)) comprising a network of interconnected empty volumes, wherein said (CCS (OR PM)) is capable of conducting or storing a charge; and a nanoparticle network (e.g, a NNN set forth herein). In yet another embodiment, in lieu using a mesh of conductive nanostructures (e.g., conductive nanotubes), also contemplated herein is the use of a porous medium (PM) capable of conducting or storing a charge, wherein said substrate comprises a plurality of pores; and a nanoparticle network (e.g, a NNN set forth herein). In these embodiments, the NNNs are intertwined within the pores of the porous medium or empty volumes of the CCS. In a particular embodiment, the pores of PM or CCS are coated with a separator layer. In another embodiment, the PM comprises a single type of material selected from silicon or carbon, or the like. In yet another embodiment, the PM comprises a plurality of types of particles selected from silicon, carbon, a binder material, and the like. In certain embodiments, the plurality of particles in the CPN are in submicron scale. In other embodiments, the plurality of particles in the CPN are in micron scale. In particular embodiments, the separator layer has a thickness of is 0.1 to 100 nanometers.

In some embodiments, the INTENS nano-device may further comprise an anodic component electrically separate from the NNN and electrically connected to the CCS (OR PM) (or PM). In some embodiments, the anodic component comprises an anodic current collector. The INTENS nano-device, in some embodiments, further comprises a cathodic component electrically separate from the CCS (OR PM) and electrically connected to the NNN. The cathodic component, in some embodiments, comprises a cathodic current collector.

The EMELA, in some embodiments, further comprises an electrolyte material comprising a medium for a transfer of ions between the CCS (OR PM) and NNN. The electrolyte material may fill interstices between the CCS (OR PM) and the NNN and promote the transfer of ions between the CCS (OR PM) and the NNN. In some aspects, the electrolyte material comprises a solvent and a solute. In other embodiments, the electrolyte material comprises a solid state electrolyte material. The solid state electrolyte material, in some embodiments, is a conductor for the ions and an insulator for electrons.

In some embodiments of the INTENS nano-device, the CCS (OR PM) comprises a silicon-based substrate and the NNN comprises a lithium-based nanoparticle-nanowire-network. In certain embodiments of the invention, the CCS (OR PM) comprises a material selected from the group consisting of one or more of: Carbon, Copper Carbon, Copper Chloride, Copper Sulfide, Copper(II) Oxide, Graphene, Graphene Oxide Monolayer, Graphite, Manganese Selenide, Potassium Graphite, Pyrolytic Graphite, Silicon, Tin Oxide, Lithium metal, and/or Zinc.

The CCS (OR PM), in some embodiments, comprises a carbon-based substrate and the NNN comprises a lithium-based nanoparticle. In certain embodiments of the invention, the MMM comprises a material selected from the group consisting of one or more of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron(III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese(IV) Oxide, Nickel Hydroxide, Silver Chromate, Silver Oxide, and/or Vanadium Pentoxide.

In some embodiments, a non-conductive separator layer is interposed between the CCS (OR PM) and the NNN. The non-conductive separator layer, in some embodiments, is an oxide layer formed on the surface of the CCS (OR PM). In some embodiments, the separator layer is deposited on the surface of the CCS (OR PM). The separator layer, in some embodiments, is a polymer layer.

In particular embodiments, the separator layer is non-planar and coats and/or envelopes substantially the entire surface area of the CCS (OR PM) (or porous conductive substrate). In another embodiment, the separator layer coats and/or envelopes the entire surface area of the CCS (OR PM) (or porous conductive substrate). Accordingly, in particular embodiments, the separator layer conforms to whatever 3-dimensional shape and/or dimension is formed by the CCS (OR PM) or porous conductive substrate. In another embodiment, the separator layer gloves the CCS (OR PM) or porous conductive substrate.

In another embodiment, it is contemplated herein the separator layer can coat and/or envelope the NNN in order to provide the separator layer interposed between the CCS (OR PM) and the NNN within the inventive INTENS nano-device.

In some aspects, a characteristic size of the empty volumes that comprise the interconnected empty volumes or pores is less than one of 100, 90, 80, 70, 60, 50, 40, 30, 20, 10, 9, 8, 7, 6, 5, 4, 3, 2, or 1 micrometers (i.e., microns). In some aspects, a characteristic size of the empty volumes that comprise the interconnected empty volumes is less than one of 900, 800, 700, 600, 500, 400, 300, 200, 100, 90, 80, 70, 60, 50, 40, 30, 20, 10, 9, 8, 7, 6, 5, 4, 3, 2, or 1 nanometers. The characteristic size may be associated with a ratio between a volume associated with the interconnected empty volumes and a surface area associated with the interconnected empty volumes.

In some embodiments, a characteristic size, e.g., a radius (for example, a largest radius, an average radius, etc.) or a ratio of between a volume associated with the nanoparticles of the NNN and a surface area of the NNN, is less than the characteristic size of the interconnected empty volumes (or the characteristic size of the empty volumes that comprise the interconnected empty volumes). The characteristic size of the nanoparticles of the NNN, in some embodiments, is less than one of 90%, 80%, 70%, 60%, 50%, 40%, 30%, 20%, and/or 10% of the characteristic size of the empty volumes. In some embodiments, a standard deviation of the size of the conductive nanoparticles is one or more of 1%, 3%, 5%, 10%, 15%, 20%, 25%, 30%, 35%, 40%, 45%, and/or 50% of the characteristic size of the conductive nanoparticles.

Also provided herein is a conductive-nanostructure-mesh-network (CNMN), comprising: a plurality of conductive nanostructures capable of conducting or storing a charge, wherein substantially all of the plurality of nanostructures are in direct contact with two or more nanostructures of the plurality of nanostructures forming a continuous CNMN. In particular embodiments, the CNMN is electrically connected to a first terminal by a subset of the nanostructures. In other embodiments, the conductive nanostructures are selected from carbon nanotubes or silicon-based nanowires. In yet further embodiments, the plurality of conductive nanostructures has a diameter in a range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the nanostructures have diameters selected from no greater than: 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 25 nm, 20 nm, 15 nm, 10 nm, 9 nm, 8 nm, 7 nm, 6 nm, 5 nm, 4 nm, 3 nm, 2 nm or 1 nm. In other embodiments, plurality of nanostructures has a length in a range selected from the group consisting of between: 0.01-500 microns, 0.02-400 microns, 0.03-300 microns, 0.04-250 microns, 0.05-200 microns, 0.06-150 microns, 0.07-125 microns, 0.08-100 microns, 0.09-90 microns, 0.1-90 microns, 0.1-80 microns, 0.1-70 microns, 0.1-60 microns, 0.1-50 microns, 0.1-40 microns, 0.2-30 microns; 0.3-20 microns; 0.4-15 microns; 0.5-10 microns; 0.7-5 microns; 0.8-4 microns; 0.9-3 microns, 1-3 microns; or the nanostructures have lengths selected from no greater than: 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 25 microns, 20 microns, 15 microns, 10 microns, 9 microns, 8 microns, 7 microns, 6 microns, 5 microns, 4 microns, 3 microns, 2 microns or 1 microns.

In some aspects, energy stored in a battery/capacitor is proportional to both the number of charge carriers and the potential difference. Almost all new technologies focused on increasing the charge carriers. Provided herein are methods and devices that improve both factors dramatically while reducing the ion current density (especially important for lithium ion-based battery technologies); and a nano-manufacturing approach for electronic and electrochemical rechargeable energy storage devices applicable to capacitors, super capacitors, and batteries, which is contemplated herein to be useful for several different applications/markets. In some aspects, the new devices, as well as methods of using and methods of making energy devices provide 10-50 times more energy storage density, 100-2000 times faster charging rates, and/or 10-100 time longer life (number of charging cycles over a device lifetime).

### BRIEF DESCRIPTION OF THE DRAWINGS

FIG. 1 is a diagram illustrating components of a current energy storage technology (e.g., a battery).

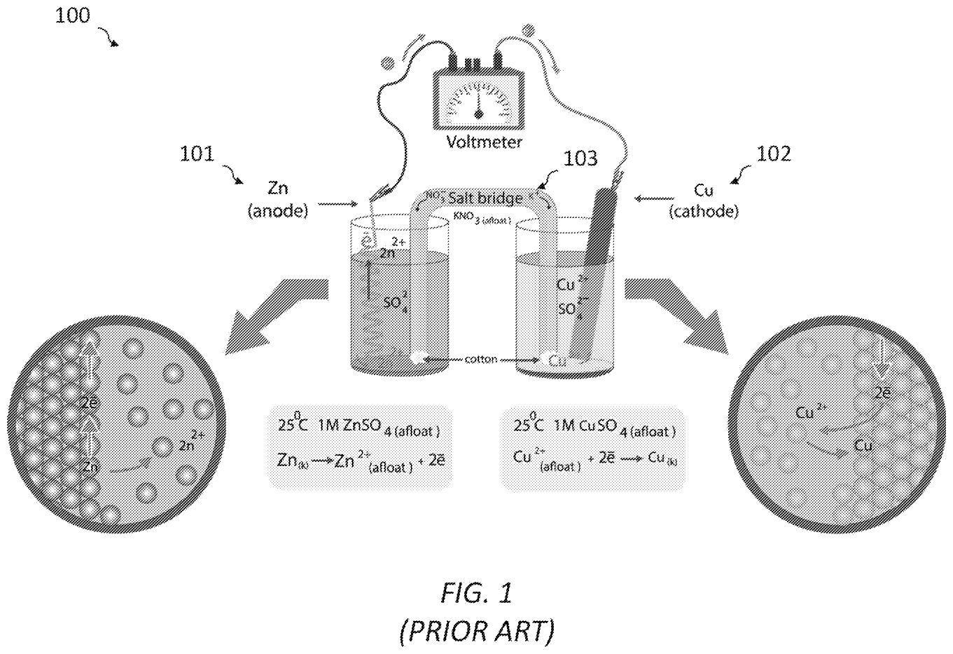

FIG. 2 is a diagram illustrates components of a lithium-ion battery in accordance with current energy storage technologies.

FIG. 3 illustrates a composite device including a first terminal, a second terminal, and a nano-device network.

FIG. 4 illustrates a set of operations used to generate a dual NNN composite device in some embodiments.

FIG. 5 includes a first diagram of a three dimensional (3-D) view of a dual network composite device, a second diagram illustrating a magnitude and direction of electric field lines, and a third diagram illustrating a charge (or voltage) associated with the components of the dual network composite device.

FIG. 6 illustrates a first diagram illustrating a conventional battery structure and a second diagram illustrating corresponding components in a dual network composite device.

FIG. 7 includes a first graph illustrating energy density ratios between the inventive composite (e.g., dual-network) device and a standard battery (e.g., energy density compared to a conventional lithium ion battery occupying the same volume and based on the same anode/cathode chemistry) for different nanoparticle sizes and average distance between nanoparticles.

FIG. 8 illustrates three embodiments of a single nanoparticle-nanowire-network ultracapacitor.

FIG. 9 illustrates an additional example of forming a single NNN.

FIG. 10 illustrates an additional example of forming a double NNN.

FIG. 11 illustrates an additional example of forming a double NNN.

FIG. 12 illustrates an additional example of forming a double NNN by sequential single network formation.

FIG. 13 illustrates an additional example of forming a double NNN by sequential single network formation for a composite device.

FIG. 14 illustrates an example of INTENS, according to an embodiment.

FIG. 15 illustrates a graph of power density versus energy density for various solutions, including different implementations of embodiments of the disclosed INTENS batteries and capacitors.

FIG. 16 is a diagram of a ‘unit’ cube of an embodiment of an INTENS structure.

FIG. 17 is a set of diagrams comparing simulations of an INTENS battery to a simulation of a typical lithium-ion battery.

FIG. 18 includes a first diagram illustrating an electric potential distribution in a cross-section of a unit feature of an INTENS capacitor.

FIG. 19 includes a first diagram of a conventional battery structure and a second diagram of the inventive battery structure in accordance with some embodiments of the disclosure.

### DETAILED DESCRIPTION

As used herein, “conductive-polymer” refers to a distinctive group of organic materials that conduct electricity, and exhibit at least some of the electrical and optical properties of both metals and semiconductors. Conductive-polymers can be formulated as polymer blends with polyimide-type materials and used as conductive composites, serving the dual role of loadbearing and electrical current dispersal. Conductive-polymers have a relatively high capacitance and high conductivity, wide potential window, high porosity, and relatively low equivalent series resistance (ESR) compared to carbon-based electrode materials making them promising candidates for supercapacitor electrode materials. Conducting polymers may store and release charge through redox processes. When oxidation occurs, ions are transferred to the polymer. When reduction occurs, the ions are released back into the solution. Due to their excellent intrinsic conductivity, conducting polymer electrodes have the greatest potential energy, power densities, and deliver high specific capacitance. An advantage of conductive polymers is their processability, mainly by dispersion. The electrical properties can be fine-tuned using the methods of organic synthesis and by advanced dispersion techniques (see, e.g., Nalwa, H. S., ed. (2000). Handbook of Nanostructured Materials and Nanotechnology. 5. New York, USA: Academic Press. pp. 501-575).

An advantage of conductive polymers is their processability, mainly by dispersion. The electrical properties can be fine-tuned using the methods of organic synthesis and by advanced dispersion techniques (see, e.g., Nalwa, H. S., ed. (2000). Handbook of Nanostructured Materials and Nanotechnology. 5. New York, USA: Academic Press. pp. 501-575).

Numerous conductive-polymer systems are well-known in the art including polyaniline, polyacetylene, polypyrrole, and poly(3,4-ethylenedioxythiophene) (PEDOT), polymer layers of carbon-silicon frameworks (CSFs), and the like. Polyaniline was first reported in 1835 as “aniline black” (Syed and Dinesan, 1991). It is a dark green powder in its conductive form and can be doped to produce high-level conductivities. Polyaniline has been successfully used as a coating to prevent the buildup of static energy in electrical components (Aldissi, 1993).

Polymer layers of carbon-silicon frameworks (CSFs) are emergent material systems. They possess electrical conductivities >106 Ω⁻¹cm⁻¹, that compare well with metallic conductivities. They are lightweight, noncorrosive, and environmentally stable. Polymer layers of interconnecting carbon frameworks and fullerene C60 and C70 molecular spheroids can potentially address the issues of conductivity and current-carrying capacity, equipotential current loadbearing density, ability, non-corrosiveness, and thermal/environmental stability. The recent decade's R&D in interconnecting carbon nanotube frameworks have ushered in a new era of continued miniaturization of integrated circuitry. Catalyst-mediated chemical-vapor-deposition growth of nanotubes has been shown to be compatible with the requirements of microelectronics technology, and can be exploited for carbon nanotubes. Semiconducting single-walled nanotubes can be successfully operated as carbon nanotube field effect transistors (CNTFET). Novel carbon-based resistive memory materials for high-density non-volatile memories have been fabricated with carbon nanotubes, graphene-like conductive carbon, and insulating carbon. Repetitive high-speed switching and the potential for multi-level programming have been successfully demonstrated.

Polyacetylene is a conducting polymer with one of the simplest structures. It was first found to conduct electricity in 1977 and later it was discovered that very heavy doping can produce conductivities similar to that of copper. Polypyrrole is a conductive polymer that is commonly used for commercial applications due to its long-term stability. It was first reported in 1916 as “pyrrole black” by the oxidation of pyrrole with hydrogen peroxide to produce an amorphous powder. The production of soluble polypyrrole is formed by graft copolymerization of pyrrole. This has led to applications such as polypyrrole-paint, polypyrrole-polyvinylchloride injection molded composites, and polypyrrole-coated fabrics and fibers (Saville, 2005).

PEDOT was developed by Bayer in the late 1980s as an antistatic coating (Geoghegan and Hadziioannou, 2013b). It has excellent transparency, good electrical conductivity (in excess of 300 Ω⁻¹cm⁻¹) and shows good stability in air and humidity. It has also been found to be stable at relatively high temperatures, with the ability to withstand 125° C. for several thousand hours. PEDOT has been doped with the water-soluble polyelectrolyte, poly (styrenesulfonate) (PSS) resulting in a good conductivity liquid solution known as PEDOT:PSS (Yoshioka and Jabbour, 2006). With more than 20 years of evolution, PEDOT has become one of the most commercially developed conductive polymers. The ability to process PEDOT in a variety of ways by doping it makes PEDOT particularly useful in the inventive nanoparticle-nanowire-networks (NNNs).

In particular embodiments, there are at least two ways that a polymer become conductive. In a first embodiment, there are conductive polymers by virtue of the chemical bonds and electronic structure of the monomer making up the polymer, like PEDOT. For example, conducting polymers may store and release charge through redox processes. When oxidation occurs, ions are transferred to the polymer.

In another embodiment, non-conductive polymers can be metalized and essentially converted into a metal nanowire. Here the polymer can be either nucleic acid or some other normally non-conductive polymer (PLL, PEI, etc). In particular embodiments, you attract metal nanoparticles or ions to the polymer to act as nucleation sites, then, grow those nucleation sites further through redox (or similar) reactions. Here the difference is that the electronic conduction is not actually through redox although the growth of metals is achieved by redox. In metallized polymers, electronic conduction is still through free electrons in the conduction band of the metal. In this particular embodiment, the polymer is not conductive, it just acts as a scaffold for metal growth.

In certain embodiments provided herein including composite-nanobatteries and composite nano-capacitors, one and two NNN configurations are disclosed. In view of this disclosure, those of skill in the art will recognize that more than 2 networks can be utilized, such as a third NNN used for the different purposes as a sensor applications or as catalytic agents. The inventive PINC 2.0 devices provided herein advantageously utilize methods of making the composite-nano-device out of interleaved NNNs. Each nanoparticle-component of the network interacts with nearby nanoparticle-components of the other networks, and that interaction creates the functionality. In particular embodiments, these are not fully functional (independent device) nanoparticle-components, their function comes from their interaction with the other nanoparticle-components in another NNN or a nanowire mesh network.

In a particular composite-nanobattery embodiment, instead of having one bulk anode and one bulk cathode, the inventive composite nanobatteries utilize a large number (10⁶ to 10²¹) of nanoparticles that are interconnected to each other within a similarly large (10⁶ to 10²⁴) network of nanostructures (nanowires). In some embodiments, each nanoparticle within a particular first NNN functions as an anode and each nanoparticle within a particular second NNN functions as a cathode. The first NNN and the second NNN, in some embodiments, are positioned or structured in a way that their distance is minimal. Minimizing the distance between elements (e.g., nanoparticles) of the first and second NNNs, may prevent the formation of dendrites. In particular embodiments, the first and second NNNs may be separated by a porous material that allows ions to flow.

As used herein, the term “nanostructure,” “nanostructures,” “nanowire,” or “nanowires” refers to any material on a nano-scale level that is able to conduct an electric current (e.g., a carbon nanotube, a conductive polymer, etc.). There are at least two ways that a polymer may be conductive: the first is metalizing a non-conductive polymer and converting it into a metal nanowire (e.g., a metalized-polymer nanowire or metalized non-conductive polymer nanowire); and the second is via an intrinsically conductive polymer, which conducts a current due to the chemical bonds and electronic structure of the particular monomer that makes up the polymer. Accordingly, exemplary nanostructures (nanowires) for use herein can be selected from a carbon nanotube, a metalized-polymer, or an intrinsically conductive-polymer.

As used herein, the phrase “metalized-polymer” refers to metalizing a substantially nonconductive-polymer (e.g., nucleic acid) to substantially convert it into a metal nanowire. In these embodiments, the polymer can be either nucleic acid or some other normally non-conductive polymer (PLL, PEI, and the like). To construct a metalized-polymer, metal nanoparticles or ions are attracted to the polymer to act as nucleation sites, then those nucleation sites are grown further through redox (or similar) reactions. The difference between a metalized-polymer and an intrinsically-conductive-polymer is that the electronic conduction of the metalized-polymer is not primarily through redox (although the growth of metals onto the polymer is done by redox). In fact, for metalized-polymers, the polymer is not conductive; it just acts as a scaffold for the growth of metal thereon, such as the growth of conductive-metal onto nucleic acid to form a metallo-nucleic acid, and the like. In metallized polymers, electronic conduction is still through free electrons in the conduction band of the metal.

As used herein, the phrase “metallo-nucleic acid” or “metalized-nucleic acid,” or grammatical variations thereof, refers to any hybrid of a conducting-metal such as Silver, Copper, Gold, Aluminium, Molybdenum, Zinc, Lithium, Brass, Nickel, Steel, Palladium, Platinium, Tungsten, Tin, Bronze, ironoxide, platinum, aluminum, or semiconductor based gallium arsenide, silicon, CdSe, ZnTe, and the like; or a lithium compound such as lithium borohydrite, lithium bromate, cobalt oxide, and the like; and any nucleic acid such as DNA, RNA, and the like. An exemplary nanowire for use herein is the silver-DNA hybrid nanowire and can be made as set forth in Kondo et al. (2017), Nature Chemistry, Vol. 9, October/2017: pges 956-960; Published Online: Jul. 3, 2017; DOI: 10.1038/NCHM.2808; which is incorporated herein by reference in its entirety for all purposes. Another silver-DNA hybrid nanowire contemplated for use herein is described and can be made as set forth in Braun et al., (February/1998) Nature, Vol 391, pgs. 775-778; which is incorporated herein by reference in its entirety for all purposes.

Other metallo-nucleic acids for use herein include the enhancement of the conductivity of DNA, via metallization, by M-DNA (metal DNA) formation through the non-specific exchange of imino protons for metal ions (Rakitin, A. et al. Metallic conduction through engineered DNA:DNA nanoelectronic building blocks. Phys Rev Lett 86, 3670-3673 (2001); gold (Fischler, M. et al. Chain-like assembly of gold nanoparticles on artificial DNA templates via ‘click chemistry’. Chem Commun (Camb), 169-171 (2008); (Timper, J. et al. Surface “click” reaction of DNA followed by directed metalization for the construction of contactable conducting nanostructures. Angew Chem Int Ed Engl 51, 7586-7588 (2012); palladium (Richter, J. et al. Nanoscale Palladium Metallization of DNA. Adv Mater 12, 507-510 (2000), and cobalt nanocluster attachment using azide-alkyne interactions or reduction-based schemes (Gu, Q., Chen, C. & Haynie, D. T. Cobalt metallization of DNA: toward magnetic nanowires. Nanotechnology 16, 1358-1363 (2005); nanoparticle-catalyzed formation of E-DNA (eccentric DNA) in GC-dominated duplexes (Eidelshtein, G. et al. Synthesis and Properties of Novel Silver-Containing DNA Molecules. Adv Mater 28, 4839-4844 (2016); nanosphere assembly from polycytosine oligonucleotides assuming an i-motif (cytosine quadruplex) configuration (Zikich, D., Liu, K., Sagiv, L., Porath, D. & Kotlyar, A. I-Motif Nanospheres: Unusual Self-Assembly of Long Cytosine Strands. Small 7, 1029-1034 (2011); and site-specific thiol functionalization in rolling circle amplification (Russell, C. et al. Gold nanowire based electrical DNA detection using rolling circle amplification. ACS Nano 8, 1147-1153 (2014), and DNA origami (Wang, R., Nuckolls, C. & Wind, S. J. Assembly of heterogeneous functional nanomaterials on DNA origami scaffolds. Angew Chem Int Ed Engl 51, 11325-11327 (2012), (Pearson, A. C. et al. DNA origami metallized site specifically to form electrically conductive nanowires. J Phys Chem B 116, 10551-10560 (2012), and (Uprety, B., Gates, E. P., Geng, Y., Woolley, A. T. & Harb, J. N. Site-specific metallization of multiple metals on a single DNA origami template. Langmuir 30, 1134-1141 (2014). Each of the journal publications cited herein are incorporated herein in their entirety for all purposes.

As used herein, “conductive-polymer” or “intrinsically-conducting-polymer,” or grammatical variations thereof, refers to a distinctive group of organic materials that, due to the chemical bonds and electronic structure of the monomer polymerizes, conducts electricity and exhibits at least some electrical and optical properties of both metals and semiconductors. Conductive-polymers can be formulated as polymer blends with polyimide-type materials and used as conductive composites, serving the dual role of loadbearing and electrical current dispersal. Conductive-polymers have a relatively high capacitance and high conductivity, wide potential window, high porosity, and relatively low ESR compared to carbon-based electrode materials making them promising candidates for supercapacitor electrode materials. Conducting polymers always store and release charge through redox processes. When oxidation occurs, ions are transferred to the polymer. When reduction occurs, the ions are released back into the solution. Due to their excellent intrinsic conductivity, conducting polymer electrodes have the greatest potential energy, power densities, and deliver high specific capacitance. An advantage of conductive polymers is their processability, mainly by dispersion. The electrical properties can be fine-tuned using the methods of organic synthesis and by advanced dispersion techniques (see, e.g., Nalwa, H. S., ed. (2000). Handbook of Nanostructured Materials and Nanotechnology. 5. New York, USA: Academic Press. pp. 501-575); which is incorporated herein by reference in its entirety for all purposes.

Numerous conductive-polymer systems are well-known in the art including polyaniline, polyacetylene, polypyrrole, and poly(3,4-ethylenedioxythiophene) (PEDOT), polymer layers of carbon-silicon frameworks (CSFs), and the like. Polyaniline was first reported in 1835 as “aniline black.” It is a dark green powder in its conductive form and can be doped to produce high-level conductivities. Polyaniline has been successfully used as a coating to prevent the buildup of static energy in electrical.

One advantage of the single- or multiple-NNN-based composite-nano-device embodiment is that a heat dissipation in the single- or multiple-NNN embodiment may be very efficient. Another advantage is that if one nano-particle in a NNN fails, the rest of the nano-particles connected in series and/or parallel within the NNN (e.g., via the nanowires) still operate, such that the inventive composite-nano-device remains operational/functional. Another advantage is that instead of requiring numerous manufacturing processes, the composite-nano-devices (e.g., nano-batteries, nano-capacitor, and the like) are self-assembled, reducing the cost significantly.

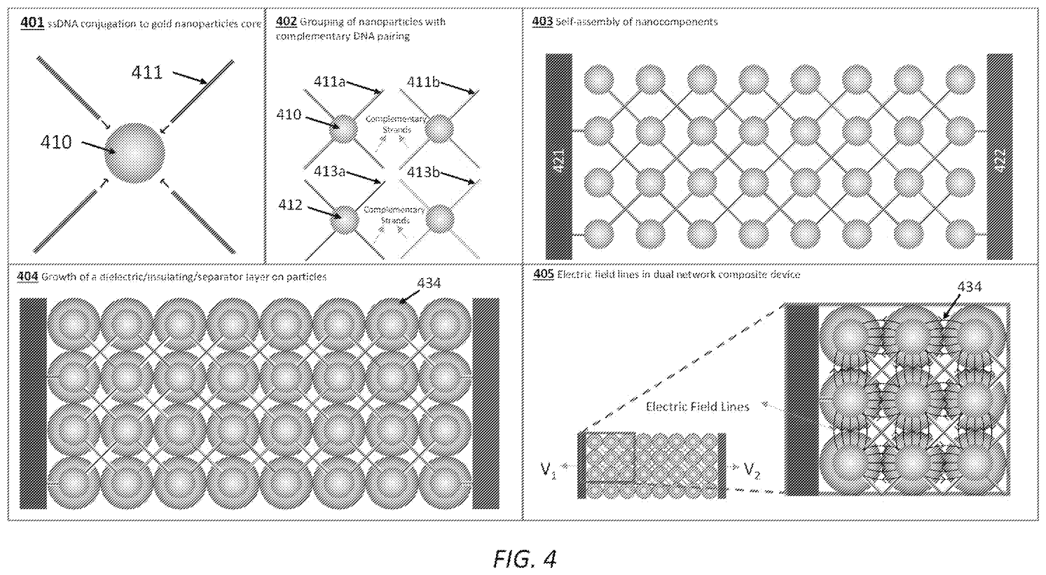

As used herein, the phrase “self-assembly” or “self-assembled” in the context of composite nano-device assembly, such as for nano-batteries, nano-capacitors, and the like described herein, refers to connecting nanowires (e.g., DNA nanowires) and their respective capture reagents (e.g., complementary oligonucleotides) to the inventive nano-components and the respective metal contacts (e.g., opposite electrodes) such that, under suitable hybridization conditions, the nano-components self-assemble within the composite-nano-device or within the respective metal contacts (see FIGS. 4-6, 8-14).

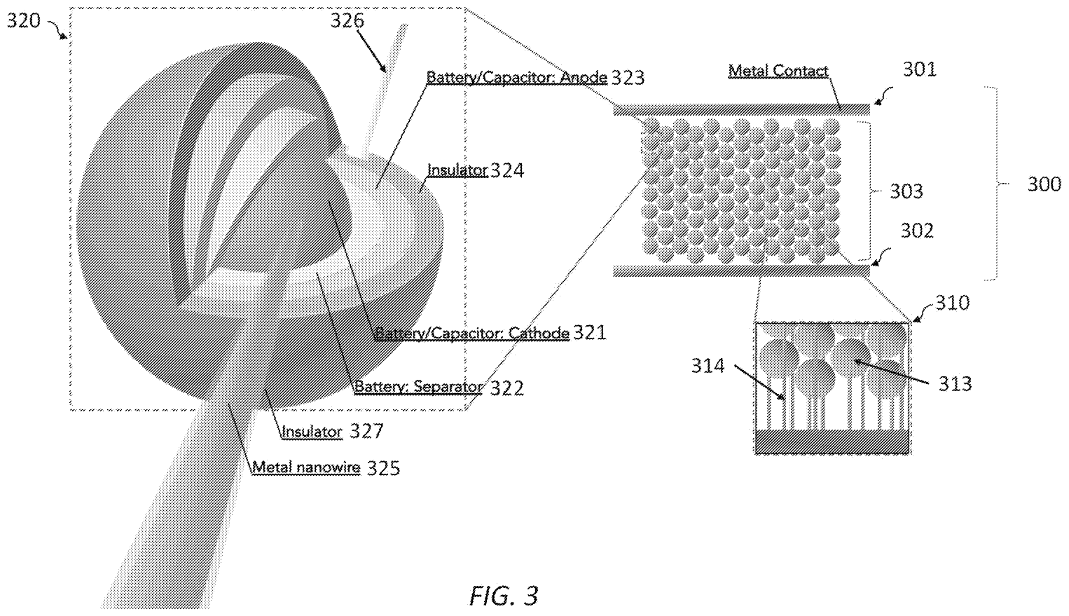

FIG. 3 illustrates a composite device 300 including a first terminal 301, a second terminal 302, and a nano-device network 303. FIG. 3 further illustrates an expanded view 310 of a connection between the nano-device network 303 (e.g., a NNN) and the second terminal 302. The connection between the nano-device network 303 (e.g., the nano-device 313) and the second terminal 302 illustrated in view 310 may be via a first set of nanowires (e.g., nanowire 314) as described above. A connection between the nano-device network 303 and the first terminal 301 may similarly be via a second set of nanowires as described above. In some embodiments, the first set of nanowires and the second set of nanowires may be of a same type or of different types.

FIG. 3 additionally includes an expanded view 320 of a particular nano-device. The nano-device may include a core material 321 (e.g., a cathode or first material), a separator layer 322, a shell material 323 (e.g., an anode or second material), an insulator 324, a first nanowire 325 electrically connecting to the core material 321, and a second nanowire 326 electrically connecting to the shell material 323. In some embodiments, the nanowires may include a metalized polymer, an inherently conductive polymer, or other nanowire disclosed above and may further include an insulating layer 327. In some embodiments the first set of nanowires may be single stranded oligonucleotides with different sequences of bases such that the first set of nanowires connects to the core material 321 and the first terminal 301 while the second set of nanowires connects to the shell material 323 and the second terminal 302. In some embodiments, the differential connection is based on oligonucleotides attached to the different components (core material 321 and first terminal 301 or shell material 323 and second terminal 302) that have different sequences of bases that are complementary to the different sequences of the first and second set of nanowires.

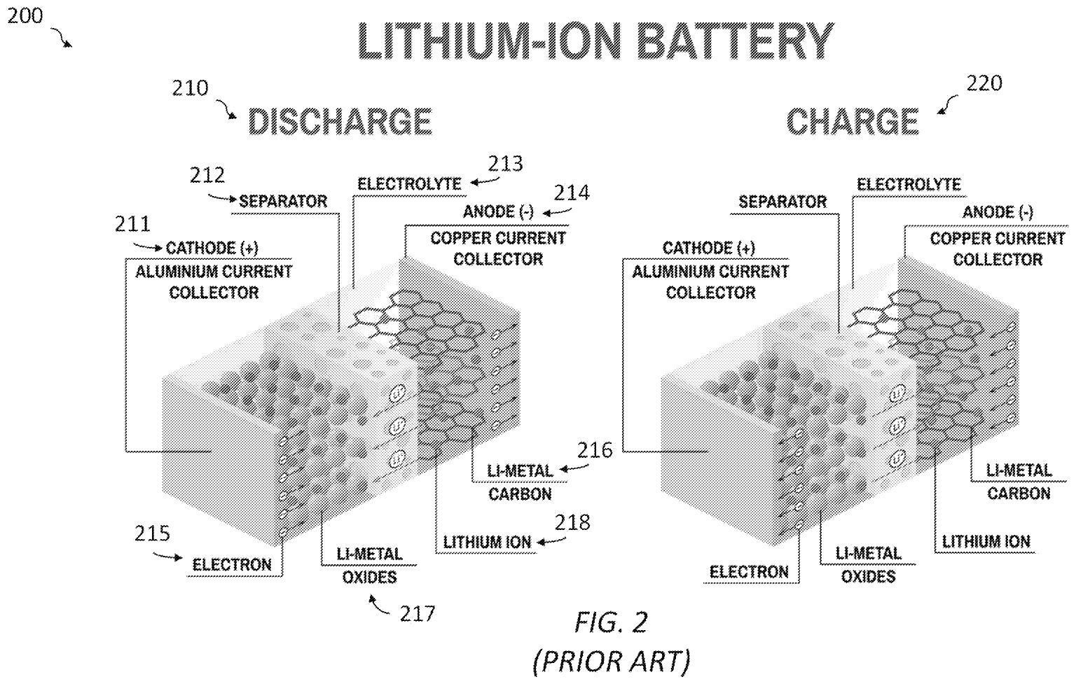

As illustrated in FIG. 3, in some embodiments, a macro-scale device (e.g., composite device 300) may be constructed based on parallel connection of multiple (e.g., 10⁶ to 10²¹) nanoscale devices (e.g., batteries) instead of being constructed from macro-scale (bulk) components. In some embodiments, the nanoscale devices provide a surface area approaching a maximum theoretical surface area for ion diffusion and a reduced ion diffusion distance, thus reducing the ion current density dramatically. For example, a surface area of a macro-scale device including nanoscale devices or components may be 10 to 1,000,000 times a conventional device of a similar volume. By reducing the ion current density and the ion diffusion distance, the individual nanoscale devices, and the macro-scale device including the nanoscale devices, may be charged more rapidly (e.g., 100 to 10,000 times faster) than a standard macro-scale device constructed from bulk components as illustrated in FIG. 2. The increased surface area, in some embodiments, further leads to superior heat management and safety.

Additionally, the macro-scale device constructed from nanoscale devices, in some embodiments, may have an energy density that is more than 10 times greater, and a power density that is more than 100 times greater, than a standard macro-scale device. In some embodiments, the nanoscale devices may be configured to self-assemble, thus reducing assembly costs. Furthermore, the nanoscale device each perform independently such that the failure of a particular nanoscale device does not affect the performance of the other nanoscale devices in the macro-scale device. The nanoscale device structure may be compatible with most known and future battery technologies and/or chemistries (e.g., solid state, lithium-metal, lithium-air, etc.)

In particular embodiments of the inventive nano-devices, e.g., a nano-battery, nano-capacitor, and the like, the diameter of the nano-device (e.g., nano-device 313) in the nano-device network 303 is selected from the group consisting of: from about 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; 20 nm to about 75 nm; from about 25 nm to about 50 nm. In other embodiments of the nano-battery, the diameter of the core, or thickness for each of the separator layer and outer layer, are each selected from the group consisting of: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 nm.

In accordance with the present invention, it has been found that the networked, in series, or in parallel, connection of numerous nanoparticles, via an inventive NNN, in composite form (a “composite-nano-device”) comprising a plurality of the respective nanoparticles, instead of using one big battery or capacitor, results in lower cost while achieving very high energy density, among other advantages. The inventive nanoparticle-nanowire-network is produced by self-assembly of nanoparticles into a larger composite form using polymers, such as, for example, DNA nanowires addressed to other nanoparticles having complementary DNA sequences and/or to electrodes or metal plates as described in the Examples herein and set forth in the Figures. In particular embodiments, the electrodes or metal plates have opposing polarity. If one or several individual nanoparticles fail, it has minimal impact on the device function. Energy density is increased as the entire volume is utilized in the most effective way.

As used herein, the phrase “composite-nano-device” as used in the context of a composite-nanobattery, composite-nanocapacitor, composite-nanosolarcell, composite-nanoLED, composite-thermoelectric-device, or the like, refers to a composite-device that functions as a single electrical, conducting, or energy unit by virtue of the integration, in series and/or in parallel, of a plurality of individual nanoparticles within a nanowire-network, such that their individual energies, electrical, power, or conductivity values are cumulative or added together and delivered from the overall composite-single-unit-device (e.g. a composite battery unit, a composite capacitor unit, a composite solarcell unit, a composite LED unit, and a composite thermoelectric unit). The number or volume of nanoparticles that can be combined in series (or in some embodiments in parallel) to form an inventive composite nano-device (e.g., a composite nanobattery, and the like) can be selected from the group consisting of at least: 10⁶, 10⁷, 10⁸, 10⁹, 10¹⁰, 10¹¹, 10¹², 10¹³, 10¹⁴, 10¹⁵, 10¹⁶, 10¹⁷, 10¹⁸, 10¹⁹, 10²⁰, and at least 10²¹ nanoparticles.

Thus, an inventive composite-nano-battery refers to a plurality of nanoparticles integrated together, either in series and/or in parallel via and inventive NNN, to form independent inventive NNNs. For the inventive nanocomposite battery, one NNN is a cathode and another NNN is an anode. Likewise, an inventive composite-nano-capacitor refers to a plurality of inventive nano-particles integrated together in series and/or parallel via and inventive NNN, to form one larger capacitor unit. Likewise, an inventive composite-nano-solarcell refers to a plurality of inventive nano-nanoparticles integrated together in series and/or in parallel via and inventive NNN, to form one larger solarcell unit. Likewise, an inventive composite-nano-LED refers to a plurality of inventive nano-particles integrated together in series and/or in parallel via and inventive NNN, to form one larger LED unit. Likewise, an inventive composite-nano-thermoelectric refers to a plurality of inventive nano-particles integrated together in series and/or in parallel via and inventive NNN, to form one larger thermoelectric unit.

In certain embodiments of the inventive composite-nanobattery-device, a first NNN is an electrode forming a cathode comprising nanoparticle material selected from the group consisting of: Bismuth Trioxide, Cobalt Oxide Particles, Iron Disulfide, Lithium Aluminum Alloy, Lithium Carbonate, Lithium Cobalt Oxide, Lithium Cobalt Phosphate, Lithium Hydroxide, Lithium Hydroxide, Lithium Iron Phosphate (LFP), Lithium Iron(III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese(IV) Oxide, Nickel Hydroxide, Silver Chromate, Silver Oxide, Vanadium Pentoxide.

In certain embodiments of the inventive composite-battery-device, a second NNN is an electrode forming an anode comprising a nanoparticle material selected from the group consisting of: Carbon, Copper Carbon, Copper Chloride, Copper Sulfide, Copper(II) Oxide, Graphene, Graphene Oxide Monolayer, Graphite, Manganese Selenide, Potassium Graphite, Pyrolytic Graphite, Silicon, Tin Oxide, lithium metal and Zinc.

In particular embodiments, each composite-nano-device, can comprise a separator-layer comprising a material that is porous to allow ion diffusion.

In particular embodiments of the inventive composite-nano-devices, such as the composite-battery-device or composite-nano-capacitor, the diameter of each nano-device, such as, e.g., the inventive nanobattery or nanocapacitor, is selected from the group consisting of: from about 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; 20 nm to about 75 nm; from about 25 nm to about 50 nm. In other embodiments of the inventive composite-nano-device, such as for example, the composite-battery-device, for each nano-device therein, such as, for example, a nano-battery, the diameter of the core, or thickness for each of the separator layer and outer layer, are each selected from the group consisting of: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 nm.

### Capacitors

In the case of capacitors, the previous improvements have focused on reducing the distance between the two electrodes and again increasing the charge capacity. However, increasing energy density by improving the porosity, thus effective thickness of the electrode does not always directly translate to energy capacity. In traditional capacitors, the electrodes can hold a great deal of charge, however the distance cannot be reduced much by existing materials. New generation capacitors try to increase the charge density of electrodes. Then, to reduce the distance they use a double layer. Use of double layers causes a very thin voltage barrier that generates an electric field. Since the electric field is inversely proportional with the distance, that very little layer helps to improve capacitance. However, the problem is that you cannot increase the total voltage, and thus the charge it carries because the double layer breaks when using high voltages.

Accordingly, provided herein is a nano-capacitor comprising: a first NNN forming a first electrode; and a second NNN forming a second electrode that is opposite from the first electrode. In particular embodiments of the nano-capacitor, the first and/or second electrode is a metal selected from the group consisting of gold, silver, iron and platinum., and the like, such that the first and second electrodes can comprise the same or different metals. Thus, those of skill in the art will understand that the first electrode “and” second electrode; as well as the first electrode “or” the second electrode is a metal selected from the group consisting of gold, silver, iron and platinum., and the like.

In particular embodiments of the nano-capacitor, a dielectric material forming the separator layer can be used, wherein the dielectric material is an oxide selected from the group consisting of MgO, TiO₂, SiO₂, or any mixture thereof, and the like.

### EXAMPLES

US 2020/0274190A1, WO2019226716A1, WO2022093406A2, U.S. Ser. No. 63/194,615, U.S. Ser. No. 63/334,661, U.S. Ser. No. 63/335,690, and U.S. Ser. No. 63/344,010 are each incorporated herein by reference in their entirety, for all purposes.

In other embodiments, the total nano-device diameter is in the range selected from the group consisting of: from about 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; 20 nm to about 75 nm; from about 25 nm to about 50 nm.

In other embodiments, the total nano-device diameter is selected from the group consisting of no greater than: 900 nm; 800 nm, 700 nm, 600 nm, 500 nm, 450 nm, 400 nm, 350 nm, 300 nm, 275 nm, 250 nm, 225 nm, 200 nm, 175 nm, 150 nm, 125 nm, 100 nm, 90 nm, 80 nm, 70 nm, 60 nm, 50 nm, 45 nm, 40 nm, 35 nm, 30 nm 25 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm and no greater than 1 nm.

In yet other embodiments, for the total particle diameter, it is contemplated herein that the diameter or thickness sizes can range into the microns, such as from 1 to about 10 microns.

### Example 1—Self-Assembly of Multiple Sets of Nanocomponents Integrated into a Nano-Device

In this particular embodiment, there are two different NNNs, a first NNN-1 and a second NNN-2. Each NNN has 2 or more single stranded oligonucleotides attached to the core and 1 or more single stranded oligonucleotides attached to the outer shell. In the first set, the single stranded oligonucleotide attached to the core has a particular sequence of bases making up the oligonucleotide, A, while the oligonucleotide(s) attached to the outer shell of the first set has a sequence B, which is different from sequence A. In the second set of nanocomponents, the sequence of 1 or more oligonucleotides attached to the core has a sequence A′, which is complementary to A while the sequence of oligonucleotides attached to the outer shell of the second set is B′, which is complementary to the sequence B. In this embodiment, the electrodes on the sides of the chamber have single stranded oligonucleotides attached with one electrode having a mixture of A and A′ oligonucleotides, while the other electrode has single stranded oligonucleotides attached with a mixture of B and B′.

Once these sets of nanocomponents (or nanoparticles) from the first and second sets are mixed in the chamber bordered by electrodes with the described single stranded oligonucleotide sequences, the nanocomponents will self-assemble to form a lattice-like structure where the cores are connected with each other through a network of double stranded DNA produced by the hybridization of A and A′; and the outer shells are connected through a network of double stranded DNA produced by the hybridization of B and B′. In this embodiment, the core network is also connected with one of the electrodes having a mixture of A and A′ oligonucleotides, while outer shell network is connected to the other electrode having a mixture of B and B′ oligonucleotides.

As used herein, the phrase “substantially all of the nano-devices,” in the context of connecting either the cores and/or the outer layers of the inventive nano-devices into a network, refers to a very high percentage of either the cores or outer layers being connected within the network, with the understanding that a small percentage of either the cores or outer layers may not be connected within the network. For example, 0.001-1% of either the cores or outer layers may not be connected within the network, without altering the overall function of the particular composite-nano-device. In other embodiments, 1% up to 10% of either the cores or outer layers may not be connected within the network, without altering the overall function of the particular composite-nano-device.

### Example 2—Preparation of Conductive Nanowires

A nanowire can be produced by the assembly of conductive nanoparticle attached oligonucleotides onto a particular DNA strand. See, for example, the methods described in Hongfei et al.: Self-Replication-Assisted Rapid Preparation of DNA Nanowires at Room Temperature and Its Biosensing Application Analytical Chemistry 2019 91 (4), 3043-3047; and Russell et al.: Gold nanowire based electrical DNA detection using rolling circle amplification (2006) ACS Nano vol: 8, issue 2, 2014, pp. 1147-; each of which are incorporated by reference herein in their entirety for all purposes.

A nanowire can be produced by the use of intercalating conductive agents, as set forth in Braun et al.: DNA-templated assembly and electrode attachment of a conducting silver wire, (1998) Nature, 19; 391(6669):775-8; Geng et al.: Rapid metallization of lambda DNA and DNA origami using a Pd seeding method (2011) Journal of Materials Chemistry, 21 (32), pp. 12126-12131; and Ijiro et al.: DNA-based silver nanowires fabricated by electroless plating (2006) Molecular Crystals and Liquid Crystals, 445:1, 207/[497]-211/[501]; each of which are incorporated by reference herein in their entirety for all purposes.

As nanowire can be produced by DNA Backbone functionalization/Charge based modification as described, for example, in Kondo et al.: A metallo-DNA nanowire with uninterrupted one-dimensional silver array (2017) Nature Chemistry, 9 (10), pp. 956-960; Keren et al.: Sequence-specific molecular lithography on single DNA molecules. (2002) Science 297, 72; and Berti et al.: DNA-templated photoinduced silver deposition (2005) J. Am. Chem. Soc. 127, 11216-11217; each of which are incorporated by reference herein in their entirety for all purposes.

### Example 3—Construction of a Dual Nanoparticle-Nanowire-Network Composite Device with Dual Network Self-Assembly after Stabilization Layer-Coating Applied

In the first step, a nucleic acid (e.g., DNA) oligonucleotide is attached to a nanoparticle. In one embodiment, thiol or a similarly functionalized single stranded oligonucleotide can be attached to the gold surface. In another embodiment, a double stranded oligonucleotide with one of the strands having thiol or similar functionalization could be attached to the nanoparticle. In another embodiment the nucleic acid can be RNA, another oligopeptide, or another oligomer, and the like. In certain embodiments, when the initially attached oligonucleotide is single stranded, a complementary strand is optionally hybridized to the single strand to strengthen the attached oligonucleotide and make it more rigid.

In particular embodiments, the nanoparticles can be metal based including, for example, ironoxide, platinum, silver, gold, aluminum, or semiconductor based gallium arsenide, silicon, CdSe, ZnTe, and the like; or a lithium compound such as lithium borohydrite, lithium bromate, cobalt oxide, and the like.

In a particular embodiment, a separation layer can be grown on the surface of the nanoparticle to sterically stabilize the nanoparticles. In some embodiments, the separation layer can have a similar charge as the oligonucleotide attached to the nanoparticle so that the building blocks/precursors are repelled during the growth/polycondensation reaction forming a hollow region around the nucleic acid oligomer. In another embodiment, the nucleic acid oligomer could be covered/coated with another layer to isolate/protect the oligomer from the growth/polycondensation reaction.

In one embodiment, a silica gel layer is formed around the nanoparticle using a precursor such as mercaptopropyl trimethoxy silane. In embodiments where the oligomer/oligonucleotide is double stranded, in order to allow further recognition with the complementary strands in future steps, the duplex can be denatured using heat/pH or another agent or any other methods known to those of skill in the art.

A plurality of nanoparticles with at least two pairs of complementary oligomer/oligonucleotide sequences attached is prepared and mixed together to form a first nanoparticle-nanowire-network. Next, a separate plurality of nanoparticles with at least two different pairs of complementary oligomer/oligonucleotide sequences attached, is prepared and mixed together to form a second nanoparticle-nanowire-network.

Next, at least two independent nanoparticle-nanowire-networks (e.g., a first and second nanoparticle-nanowire-network) where each network contains connected nanoparticles are combined in an enclosure-device. In the enclosure-device, there are two different electrodes. Each electrode corresponds to two different ports, poles, polarities, anodes, cathodes, that are connected to an external circuit. Each electrode has capture probes, which are oligonucleotides, or the like, that have complementary sequences to only the pairs of nucleic acid sequences from one of the networks. Therefore, all of the components of each of the nanoparticle-nanowire-networks are connected to only one of the electrodes.

Nanoparticles are dispersed randomly and each nanoparticle from one of the networks has a comparable average distance with each nanoparticle from the other network. Therefore, there will be an interaction between the nanoparticles of one network and the nanoparticles in the other network based on the external influence/perturbation

In one embodiment of the inventive composite-nanocapacitor, two networks of gold/silica core/shell nanoparticles are formed. Different voltage values V1 and V2 are applied to each of the electrodes resulting in electrical field formed between each of the nanoparticles of the first nanoparticle-nanowire-network with each of the nanoparticles in the second nanoparticle-nanowire-network. In particular embodiments, the electric field strength is highest between the closest pair of nanoparticles. In this particular embodiment, the silica shell of each nanoparticle within the network acts as a dielectric layer between the electrodes of the capacitor, therefore generating capacitance between each nanoparticle pair, resulting in an aggregate capacitance between the electrodes.

### Example 4—Construction of a Dual Nanoparticle-Nanowire-Network Composite Device with Dual Network Self-Assembly Prior to Optional Stabilization Layer

In the first step, a nucleic acid (e.g., DNA) oligonucleotide is attached to the nanoparticle. In one embodiment, thiol or a similarly functionalized single stranded oligonucleotide can be attached to the gold surface. In another embodiment, a double stranded oligonucleotide with one of the strands having thiol or similar functionalization could be attached to the nanoparticle. In another embodiment the nucleic acid can be RNA, another oligopeptide, or another oligomer, and the like.

In other embodiments, the nanoparticles can be metal based selected from the group consisting of, for example, Silver, Copper, Gold, Aluminum, Molybdenum, Zinc, Lithium, Brass, Nickel, Steel, Palladium, Platinum, Tungsten, Tin, Bronze, ironoxide, platinum, aluminum, or semiconductor based gallium arsenide, silicon, CdSe, ZnTe, and the like; or a lithium compound such as lithium borohydrite, lithium bromate, cobalt oxide, and the like.

A plurality of nanoparticles with at least two pairs of complementary oligomer/oligonucleotide sequences attached is prepared and mixed together to form a first nanoparticle-nanowire-network. Next, a separate plurality of nanoparticles with at least two different pairs of complementary oligomer/oligonucleotide sequences attached, is prepared and mixed together to form a second nanoparticle-nanowire-network.

Next, at least two independent nanoparticle-nanowire-networks (e.g., a first and second nanoparticle-nanowire-network) where each network contains connected nanoparticles are combined in an enclosure-device. In the enclosure-device, there are two different electrodes. Each electrode corresponds to two different ports, poles, polarities, anodes, cathodes, that are connected to an external circuit. Each electrode has capture probes, which are oligonucleotides, or the like, that have complementary sequences to only the pairs of nucleic acid sequences from one of the networks. Therefore, all of the components of each of the nanoparticle-nanowire-networks are connected to only one of the electrodes.

In a particular embodiment, a separation layer can be grown on the surface of the nanoparticle to sterically stabilize the nanoparticles. In some embodiments, the separation layer can have a similar charge as the oligonucleotide attached to the nanoparticle so that the building blocks/precursors are repelled during the growth/polycondensation reaction forming a hollow region around the nucleic acid oligomer. In another embodiment, the nucleic acid oligomer could be covered/coated with another layer to isolate/protect the oligomer from the growth/polycondensation reaction.

In one embodiment, a silica gel separation layer is formed around the nanoparticle using a precursor such as mercaptopropyl trimethoxy silane. In another embodiment, the polycondensation/polymerization/reaction is continued further to fill in the entire enclosure.

In another embodiment, the separation layer can be in the form of spikes around the nanoparticles corresponding to poly ethylene glycol (PEG). PEGs are non-toxic, FDA-approved, generally nonimmunogenic, and are frequently used in many biomedical applications including. As set forth herein, the separation layer could also be another polymer well-known in the art, either absorbed or covalently attached to the surface of the nanoparticle; or as set forth herein, can be silica/silica gel or any other sol-gel. In particular embodiments, PEG is used; and can be selected from a broad range of sizes well-known in the art, such as, for example, PEG 200 Da, 2 KDa, 5 KDa, 10 KDa, 20 KDa, 40 KDa, or higher.

For example, FIG. 4 illustrates a set of operations used to generate a dual NNN composite device in some embodiments. In a first stage 401, thiol or similar functionalized single stranded oligonucleotide 411 may be attached to a surface of a (gold) nanoparticle 410. In another embodiment, a double stranded oligonucleotide with one of the strands having thiol or similar functionalization may be attached to the nanoparticle. In yet another embodiment, the DNA may instead be RNA, another oligopeptide, or another oligomer. In other embodiments, the nanoparticles may be metal-based including iron oxide, platinum, silver, aluminum, or semiconductor based gallium arsenide, silicon, CdSe, ZnTe, or a lithium compound such as lithium borohydrite, lithium bromate, or cobalt oxide.

At a second stage 402, nanoparticles 410 and 412 with at least two pairs of complementary oligomer/oligonucleotide sequences (e.g., 411a/411b and 413a/413b, respectively) may be prepared and mixed. At a third stage 403, the nanoparticles 410 may form (e.g., self-assemble into) a first network (NNN-1) and the nanoparticles 412 may form (e.g., self-assemble into) a second network (NNN-2) based on the matching of the complementary oligomer/oligonucleotide sequences. During the third stage 403, a first terminal 421 may also have one pair of complementary oligomer/oligonucleotide sequences (e.g., 411a/411b) attached to the surface such that the first network (NNN-1) including the nanoparticles 410 further includes the terminal 421. Similarly, the second terminal 422 may also have one pair of complementary oligomer/oligonucleotide sequences (e.g., 413a/413b) attached to the surface such that the second network (NNN-2) including the nanoparticles 412 further includes the terminal 422. Accordingly, at least two independent networks are formed in an enclosure between the two terminals, where each independent network contains connected nanoparticles. In the structure, there are two different electrodes (e.g., terminals), where each electrode corresponds to one of two different ports/poles/polarities/anodes/cathodes that are connected to an external circuit. Each electrode has different capture probes (e.g., oligonucleotides or the like) that have complementary sequences to only one of the networks. Therefore, as described above, all of the components of each of the independent networks are connected to only one of the electrodes.

During the fourth stage 404 a dielectric, insulating, and/or separator layer 434 could be grown on the surface to stabilize the nanoparticles. The layer 434 could have a similar charge as the oligonucleotide (e.g., 411a/411b or 413a/413b) so that the building blocks/precursors are repelled during the growth/polycondensation reaction forming a hollow region around the oligomer. In another embodiment, the oligomer could be covered/coated with another layer to isolate/protect the oligomer from the growth/polycondensation reaction. In one embodiment, a silica gel layer is formed around the nanoparticle using a precursor such as mercaptopropyl trimethoxy silane. In another embodiment, the polycondensation/polymerization reaction could be continued further to fill the entire enclosure.

During a fifth stage 405 the first terminal 421 may be connected to a first source at a first potential energy (e.g., voltage V1) and the second terminal 422 may be connected to a second source at a second (opposing) potential energy (e.g., voltage V2). As used herein, the term opposing potentials, opposing terminals, or opposite charge may refer to potentials above and below a reference potential, terminals at opposing potentials, or charges (e.g., a charge density) above and below a reference charge (e.g., charge density). Electric field lines indicate that the electric field is strongest between nearest neighbors of different networks, in some embodiments.

### Example 5—Construction of a Dual Nanoparticle-Nanowire-Network Composite Device with Dual Networks

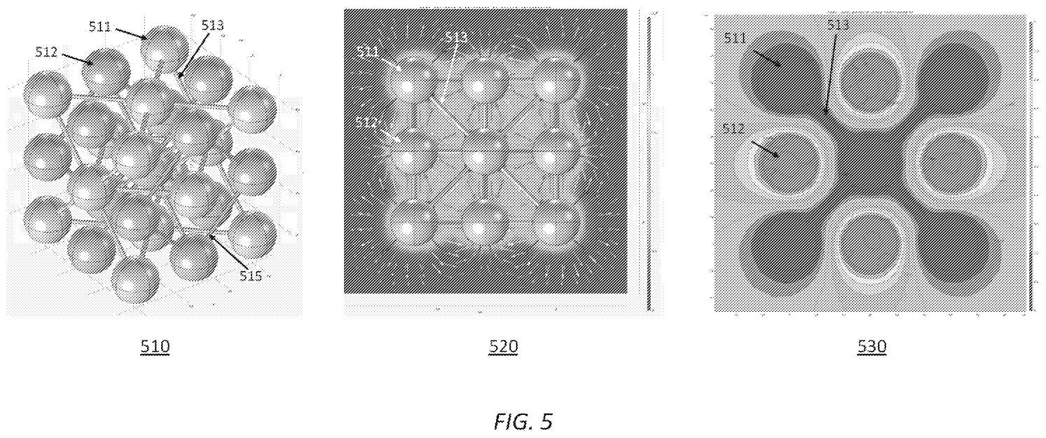

FIG. 5 includes a first diagram 510 of a three dimensional (3-D) view of a dual network composite device, a second diagram 520 illustrating a magnitude and direction of electric field lines, and a third diagram 530 illustrating a charge (or voltage) associated with the components of the dual network composite device. The first diagram 510 includes a first network of nanoparticles 511 and nanowires 513 (e.g., a NNN, NNN-1) and a second network of nanoparticles 512 and nanowires 515 (e.g., a NNN, NNN-2). Diagram 520 illustrates a set of electric field lines in a 2-D cross-section of the dual network composite device of diagram 510. Similarly, diagram 530 illustrates a voltage (e.g., a relative electric potential) associated with the components of the dual network component device.

In this embodiment, two separate networks of nanoparticles may be prepared as described in relation to FIG. 4. The two networks are interleaved with each other in all three dimensions as illustrated in FIG. 5. In this particular embodiment, each nanoparticle (e.g., nanoparticle 511 or 512) may have a diameter of 20 nanometers and the nanoparticles may be 30 nm apart from each other center to center. In some embodiments, the spacing and/or structure illustrated in diagram 510 may be likely if each nanoparticle is randomly distributed in solution and either carries a particular charge or is sterically stabilized in solution such that they position themselves apart from each other. In this configuration, each network will correspond to one of the polarities of the device. For example, for batteries, one network may be a network of anodes, the other network may be a network of cathodes; for capacitors, one network may be a network of positive electrodes and the other network may be a network of negative electrodes (where negative and positive are relative to a reference voltage in between the negative and positive voltages identified as a “zero” voltage), and the like. In some embodiments, the nanowires (e.g., DNA, nanowires 513 and/or 515) that link the nanoparticles may also be charged and they may also position themselves away from the other nanowires that present a similar charge. The configuration illustrated in FIG. 5 depicts one of the possible configurations when the local nanoparticle density is very high.

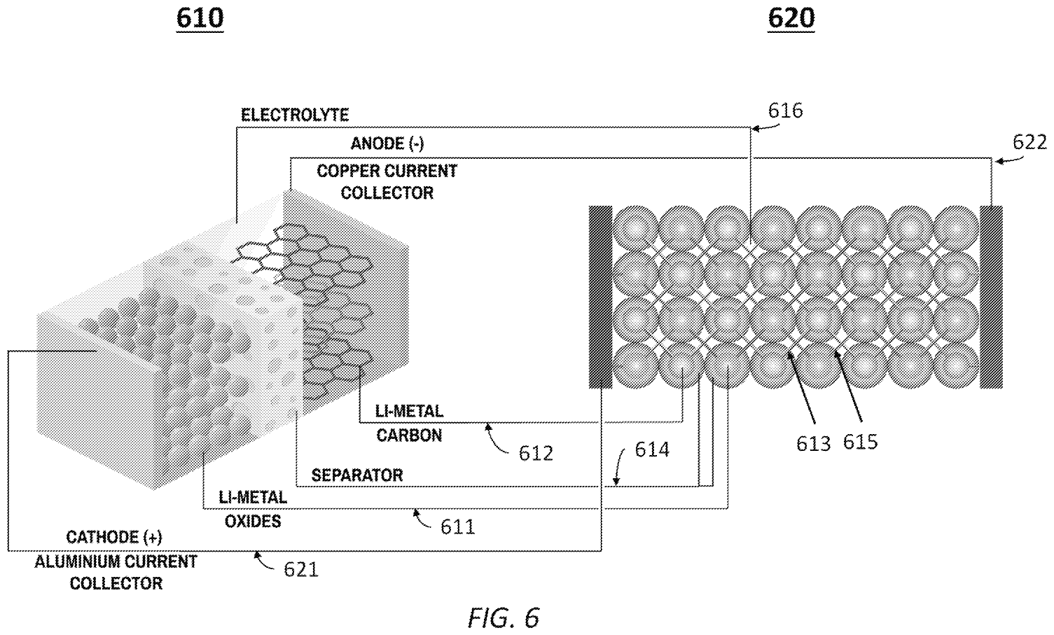

FIG. 6 illustrates a first diagram 610 illustrating a conventional battery structure and a second diagram 620 illustrating corresponding components in a dual network composite device. The composite device may include a first NNN including a first set of nanoparticles 611 and nanowires 615 and a second NNN including a second set of nanoparticles 612 and nanowires 613. A separator layer 614 may be generated, deposited, applied, and/or grown on the nanoparticles 611 and 612 and an electrolyte 616 may be introduced to fill the remaining unfilled volume (space) between the coated nanoparticles.

### Example 6—A Dual Nanoparticle-Nanowire-Network Composite—Battery

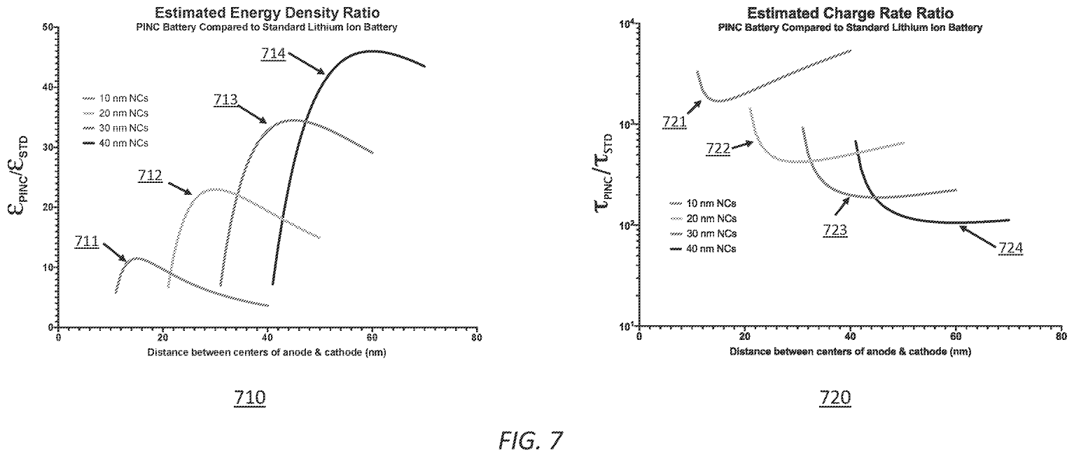

FIG. 7 includes a first diagram 710 illustrating energy density ratios between the inventive composite (e.g., dual-network) device and a standard battery (e.g., energy density compared to a conventional lithium ion battery occupying the same volume and based on the same anode/cathode chemistry) for different nanoparticle sizes and average distance between nanoparticles. FIG. 7 further includes a second diagram 720 illustrating estimated charge rate ratios between the inventive composite (e.g., dual-network) device and a standard battery for different nanoparticle sizes and average distance between nanoparticles. First diagram 710 includes a curve 711 for a 10 nm nanoparticle, a curve 712 for a 20 nm nanoparticle, a curve 713 for a 30 nm nanoparticle, and a curve 714 for a 40 nm nanoparticle. Second diagram 720 includes a curve 721 for a 10 nm nanoparticle, a curve 722 for a 20 nm nanoparticle, a curve 723 for a 30 nm nanoparticle, and a curve 724 for a 40 nm nanoparticle. As can be seen from first diagram 710, the energy storage capacity tends to increase as the diameter of nanoparticles increase. As shown in second diagram 720, the smaller the nanoparticles the faster they may charge/discharge for a same spacing relative to the size of the nanoparticles (e.g., an inter-nanoparticle distance that is 1.5 times the nanoparticle diameter).

This set of data shows the flexibility of the inventive dual network (PINC 2.0) methodology and provides a modular approach to those of skill in the art to design devices with appropriate characteristics for the target applications. These results will differ based on the material properties of the components, such as, for example, the material that the nanoparticles are made of (e.g., a core, shell or another stabilization functionalization), and the material(s) that fill the gap in between the nanoparticles as either a separation/stabilizing later or other filler (e.g., solution, gel, electrolyte, and the like).

### Example 7—A Dual Nanoparticle-Nanowire-Network Composite—Nanocapacitor

Referring back to FIG. 5, diagram 520 shows the view of the dual-nanoparticle-nanowire-network (dual-NNN) capacitor configuration from one side (a 2-D cross-section of the top plane of the dual network device in 510). In the illustrated embodiment, one of the networks (e.g., NNNs) is grounded, while a net voltage (e.g., 1V) is applied to the other network. Diagram 520 shows the magnitude and direction of electric field lines. This configuration generates a capacitance that leads to energy storage within the electric fields. As shown in diagram 530, the nanowires carry charge, and they also contribute to the overall capacitance of the composite-nanocapacitor. In this particular embodiment, the nanowires increase the total capacitance by approximately 20%, and thus contribute to the total energy stored.

### Example 8—Ultracapacitor Configuration From a Single Nanoparticle-Nanowire-Network (NNN)

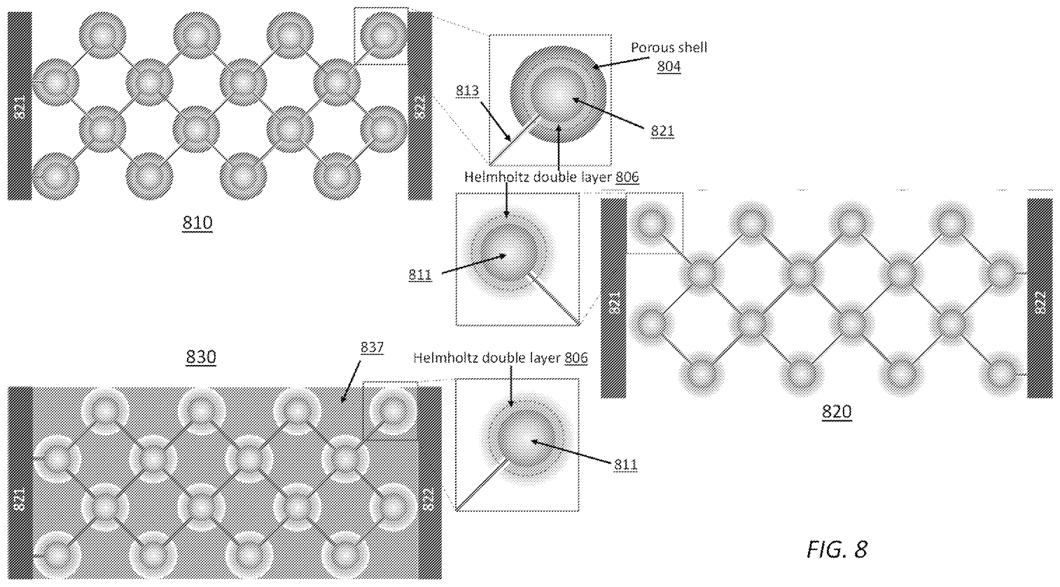

FIG. 8 illustrates three embodiments of a single nanoparticle-nanowire-network ultracapacitor. In the embodiments illustrated in diagrams 810, 820, and 830, there may be only one network of nanoparticles (e.g., a nanoparticle-nanowire-network) and the nanoparticles may be suspended in an electrolyte solution. When a voltage is applied to the network a double layer of charge 806 is formed, causing a separation of charge, and thus generating a capacitance in the interface. Core shell nanoparticles 811 with a conductive core and porous shell 804 (diagram 810) or conductive nanoparticles 811 without a shell (diagrams 820 and 830) can be utilized in this configuration. Diagram 830 illustrates that, in some embodiments, the space between the particles and nanowires may be filled with a liquid, a gel, or other porous material 837. For example, in some embodiments, the space may be filled with an electrolytic fluid and the nanoparticles may be suspended in liquid and held together with flexible or solid nanowires 813. In other embodiments, the space between the particles and nanowires may be filled with a porous material (i.e. a gel; sol-gel; polymer-based material; solid porous material like silica, titanium oxide, silicon, or other similar materials).

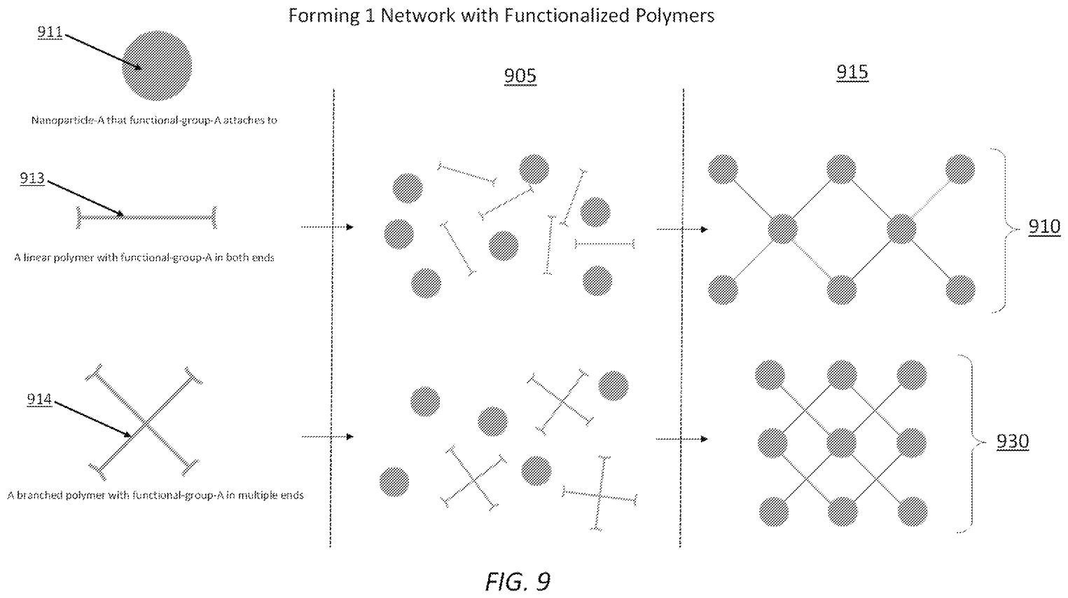

FIG. 9 illustrates an additional example of forming a single NNN 910 and/or 930. The single NNNs 910 and 930, in some embodiments, may be formed from a linear polymer 913, or a branched polymer 914, with a functional-group-A to which an A-type nanoparticle 911 may attach as described in relation to FIG. 4 above. At a first stage 905, the A-type nanoparticles and the functional group polymers (e.g., linear polymers 913 or branched polymers 914) may be introduced in solution. At a second stage 915, the single NNN may self-assemble into NNN 910 or 930 based on connections between the functional-group-A of the polymer and the nanoparticle 911.

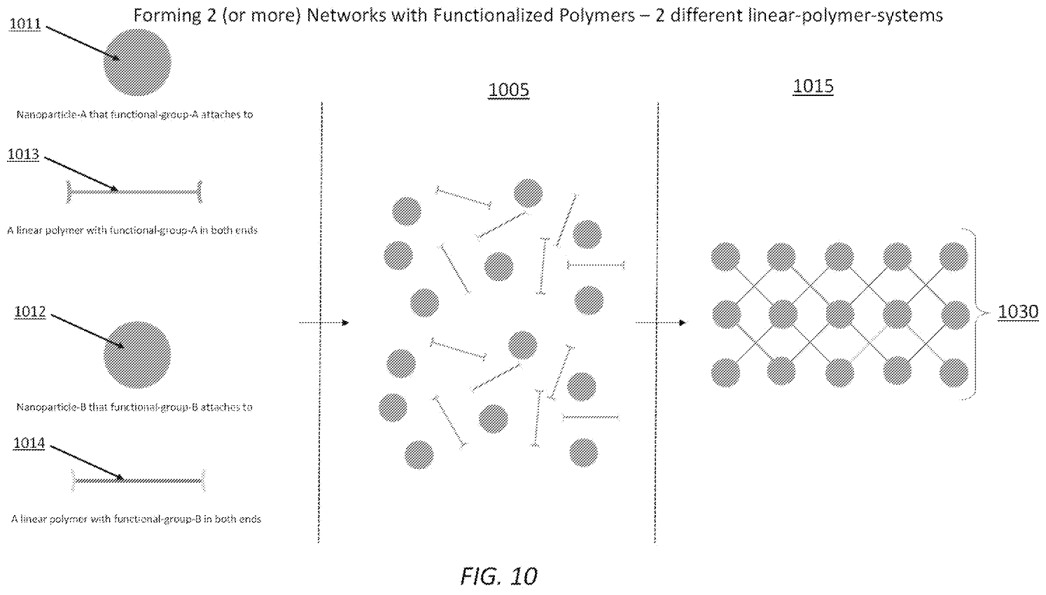

FIG. 10 illustrates an additional example of forming a double NNN 1030. The double NNN 1030, in some embodiments, may be formed from a linear polymer 1013 with a functional-group-A to which an A-type nanoparticle 1011 may attach and a linear polymer 1014 with a functional-group-B to which a B-type nanoparticle 1012 may attach that form two independent NNNs as described in relation to FIG. 4 above. At a first stage 1005, the A-type nanoparticles 1011, B-type nanoparticles 1012, functional-group-A polymers 1013, and functional-group-B polymers 1014 may be introduced in solution. At a second stage 1015, the components of the two independent NNNs may self-assemble into NNN 1030 based on connections between the functional-group-A of the polymers 1013 and the A-type nanoparticles 1011 and connections between the functional-group-B polymers 1014 and the B-type nanoparticles 1012.

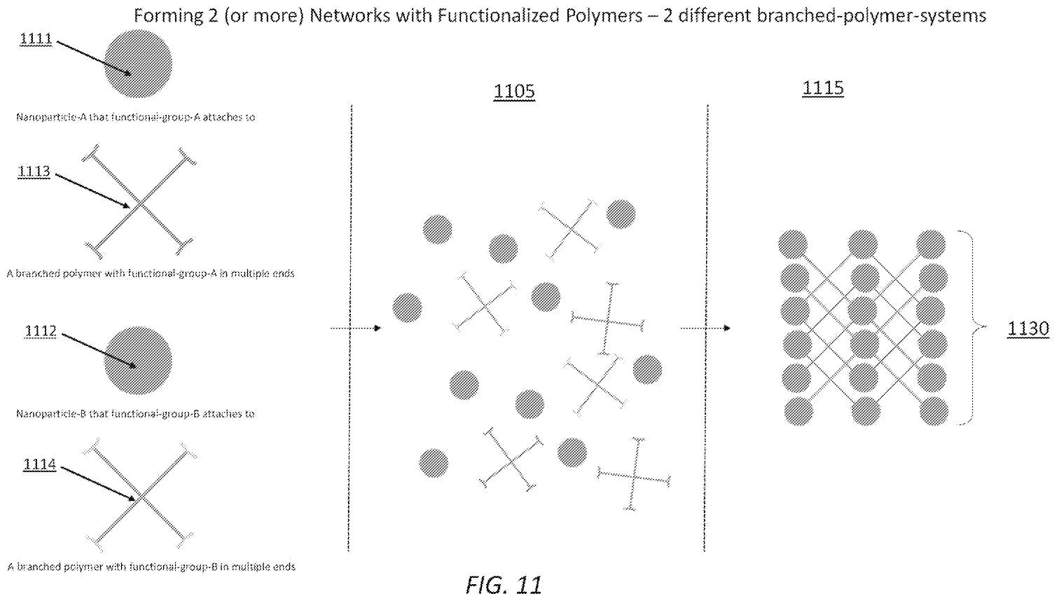

FIG. 11 illustrates an additional example of forming a double NNN 1130. The double NNN 1130, in some embodiments, may be formed from a branched polymer 1113 with a functional-group-A to which an A-type nanoparticle 1111 may attach and a branched polymer 1114 with a functional-group-B to which a B-type nanoparticle 1112 may attach that form two independent NNNs as described in relation to FIG. 4 above. At a first stage 1105, the A-type nanoparticles 1111, B-type nanoparticles 1112, functional-group-A polymers 1113, and functional-group-B polymers 1114 may be introduced in solution. At a second stage 1115, the components of the two independent NNNs may self-assemble into NNN 1130 based on connections between the functional-group-A of the polymers 1113 and the A-type nanoparticles 1111 and connections between the functional-group-B polymers 1114 and the B-type nanoparticles 1112.

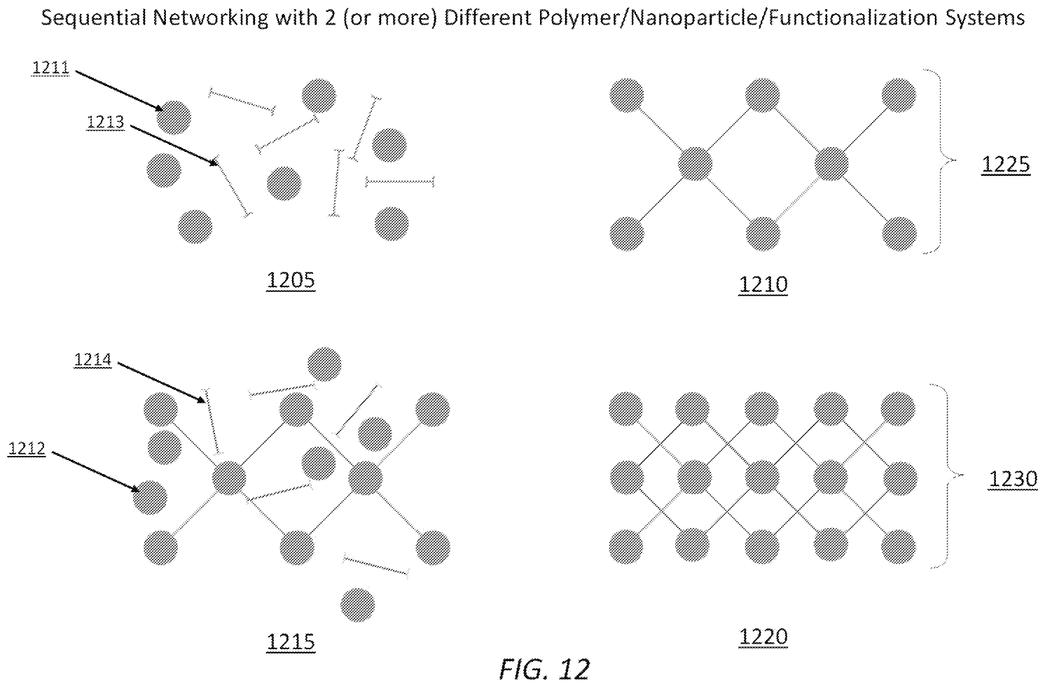

FIG. 12 illustrates an additional example of forming a double NNN 1230 by sequential single network formation. A first NNN 1225, in some embodiments, may be formed from a linear polymer 1213 with a functional-group-A to which an A-type nanoparticle 1211 may attach, while a second NNN may be formed from a linear polymer 1214 with a functional-group-B to which a B-type nanoparticle 1212 may attach as described in relation to FIG. 4 above. At a first stage 1205, the A-type nanoparticles 1211 and the functional-group-A polymers 1213 may be introduced in solution. At a second stage 1210, the single NNN may self-assemble into NNN 1225 based on connections between the functional-group-A of the polymer 1213 and the A-type nanoparticle 1211. At a third stage 1215, the B-type nanoparticles 1212 and the functional-group-B polymers 1214 may be introduced in solution with the first NNN 1225. At a fourth stage 1220, the second NNN may self-assemble around and/or between NNN 1225 to form the double NNN 1230 based on connections between the functional-group-B of the polymer 1214 and the B-type nanoparticle 1212.

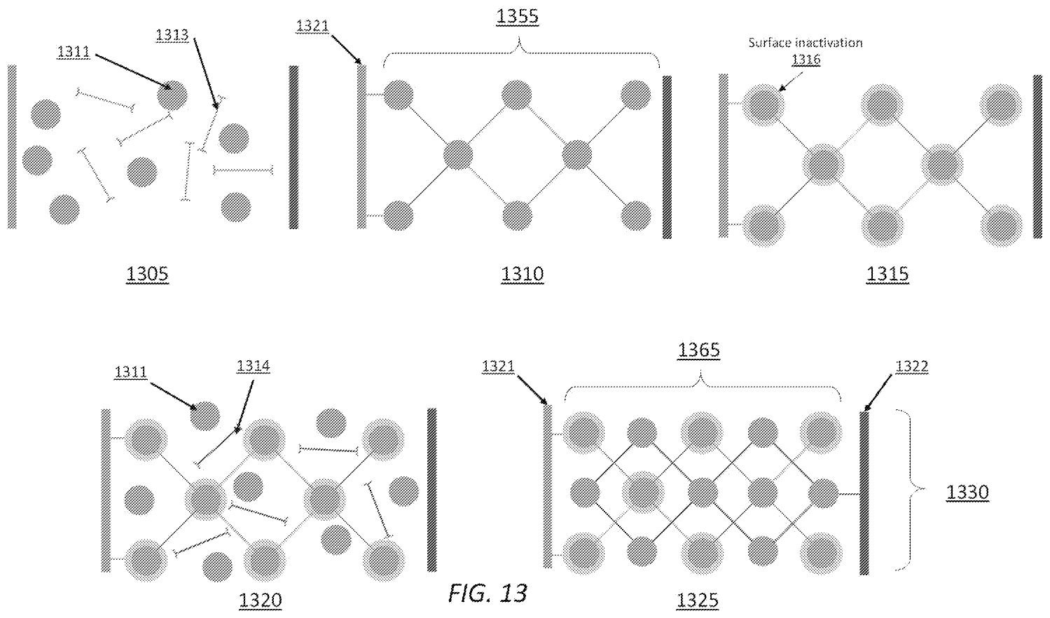

FIG. 13 illustrates an additional example of forming a double NNN 1365 by sequential single network formation for a composite device 1330. A first NNN 1355, in some embodiments, may be formed from a linear polymer 1313 with a functional-group-A to which an A-type nanoparticle 1311 may attach as described in relation to FIG. 4 above. At a first stage 1305, the A-type nanoparticles 1311 and the functional-group-A polymers 1313 may be introduced in solution. At a second stage 1310, the single NNN components 1311 and 1313 may self-assemble into NNN 1325 attached to terminal 1321 based on connections between the functional-group-A of the polymer 1313 and the A-type nanoparticle 1311 and/or a target on the terminal 1321 (e.g., based on the polymer backbone instead of the functional-group-A). At a third stage 1315 the surface of the nanoparticles 1311 may be inactivated by surface inactivation agent 1316 (e.g., a coating or shell generated, deposited, applied, and/or grown on the nanoparticles 1311) such that they will no longer connect to additional functional-group-A polymers 1313. At a fourth stage 1320, Additional A-type nanoparticles 1311 and a second type (e.g., using a different polymer backbone) of functional-group-A polymers 1314 may be introduced in solution with the first NNN 1355 (but will not add to the first NNN because of the surface inactivation agent 1316. At a fifth stage 1325, the second NNN may self-assemble around and/or between NNN 1355 to form the double NNN 1365 based on connections between the functional-group-A of the polymer 1314 and the A-type nanoparticle 1311 and/or a target on the terminal 1322 (e.g., based on the polymer backbone instead of the functional-group-A).

At a first stage 1205, the A-type nanoparticles 1211, B-type nanoparticles 1212, functional-group-A polymers 1213, and functional-group-B polymers 1214 may be introduced in solution. At a second stage 1215, the components of the two independent NNNs may self-assemble into NNN 1230 based on connections between the functional-group-A of the polymers 1213 and the A-type nanoparticles 1211 and connections between the functional-group-B polymers 1214 and the B-type nanoparticles 1212. At a first stage 1205, the A-type nanoparticles 1211, B-type nanoparticles 1212, functional-group-A polymers 1213, and functional-group-B polymers 1214 may be introduced in solution.

(e.g., a nanoparticle to which a nanowire (e.g., oligonucleotide, oligomer, etc.) with a functional group A attacheds) a

In another embodiment, the inventive ultracapacitor configuration can be achieved with two nanoparticle-nanowire-networks, (dual NNNs) as described in relation to FIGS. 4 and 5 with different voltage levels applied to each network.

In other embodiments, electrostatic double-layer capacitors (EDLCs) with carbon (or carbon derivative) electrodes; electrochemical pseudocapacitors that utilize metal oxide or conducting polymer electrodes, in which, electrochemical pseudocapacitance is combined with double-layer capacitance; or hybrid capacitors (i.e., lithium-ion capacitor) can also be assembled using the inventive methods provided herein.

Certain embodiments above utilize dual NNNs in a nano-device. For example, a first NNN comprises cathodes and a second NNN comprises anodes (e.g., in the case of a nanobattery). In these embodiments, both nanoparticle networks in the nano-device were formed by a plurality of nanoparticles connected by nanowires.

### Intertwined Electrode Networks (INTENS)

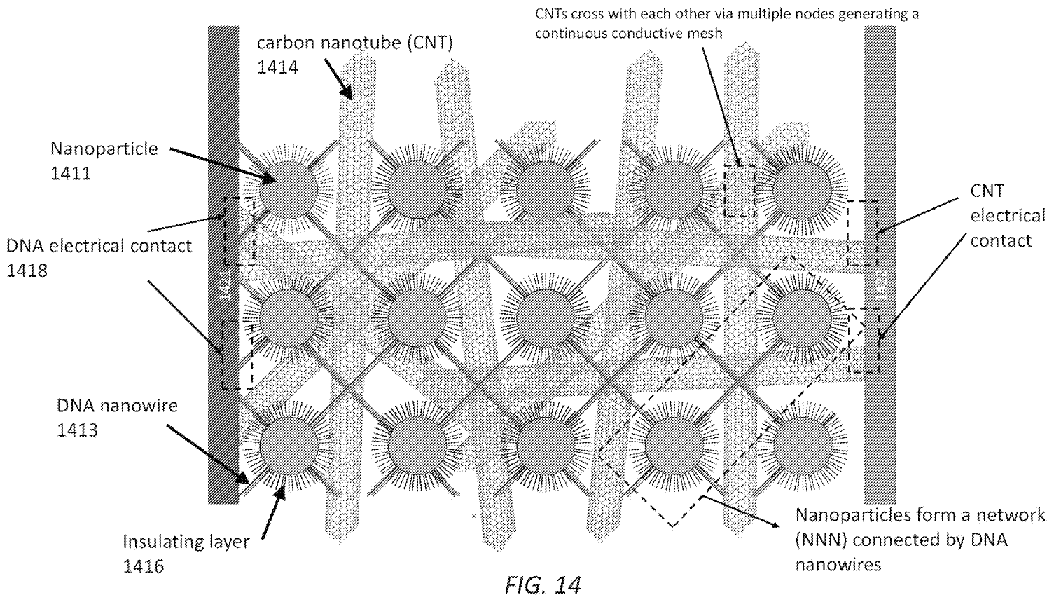

In an alternative embodiment, referred to herein as intertwined electrode networks (INTENS), one of the NNNs in the nano-device may be replaced by a mesh of interconnected carbon nanotubes, or the like (see FIG. 14). In other words, instead of dual NNNs, the nano-device comprises a single NNN (comprising a network of nanoparticles connected by nanowires, as described elsewhere herein) and a nano-mesh-network (NMN) of carbon nanotubes, or the like. While this alternative embodiment will primarily be described as comprising a mesh of carbon nanotubes as the nano-mesh-network (NMN), those of skill in the art will readily understand that in addition to carbon nanotubes, the phrase nano-mesh-network (NMN) also refers to the use of conductive polymers, metallized polymers, metallized or non-metallized single/double (or more) stranded DNA (or other nucleotide analogues, such as PNA or the like), or other conductive or metallized polymers to form the inventive nano-mesh-network (NMN). Thus, it should be understood that, in the present disclosure, any reference to carbon nanotubes may be replaced by a reference to any of those other suitable materials.

With the exception of the replacement of one of the NNNs with an inventive NMN (e.g., a mesh of interconnected carbon nanotubes, or the like), the nano-device may operate in the same manner and with the same components as any of the other embodiments described herein. Thus, the descriptions of other embodiments can be similarly or equally applied to the nano-device of this alternative embodiment.

Similarly, also contemplated herein, is a porous conductive substrate that may be used in place of the NMN. The porous conductive substrate may be a silicon-based material with a network of interconnected empty volumes that may be filled with, intertwined with, and or injected with a NNN as described herein.

In a particular embodiment, the nano-device is a capacitor comprising an NNN and a NMN. In this capacitor embodiment, the NNN may comprise metal nanoparticles, such as gold, silver, aluminum, copper, iron oxide, and the like. The NNN may also comprise nanowires that are metallized or non-metallized single/double (or more) stranded DNA (or other nucleotide analogue, such as PNA or the like), or other conductive or metallized polymers. The other network is an NMN, e.g., a mesh of interconnected carbon nanotubes, or the like. It should be understood that each network operates as an electrode.

Advantageously, this inventive nano-capacitor benefits from one or more of the following:
The shortening of the distance between the electrodes increases capacitance and forms electric fields with neighboring electrodes in three dimensions.
Can utilize various different materials as the dielectric.
Voltage dependent on the distance.
Capacitance dependent on the voltage.
As the distance decreases, capacitance decreases, but the total voltage increases as the breakdown voltage increases, such that various configurations can be accommodated.
The inventive capacitor can store energy as well as supercapacitors, if not better, and has additional benefits over supercapacitors. For example, even the best supercapacitors lose about 20% of their energy per day, and therefore, are not suitable for long-term storage. Accordingly, supercapacitors are only used for very short-term storage. On the other hand, the disclosed capacitor can store energy for a very long time, while matching or exceeding the specific energy of supercapacitors. The disclosed capacitor is a very stable energy storage device that can hold its charge for a very long time. The number of cycles that the disclose capacitor can go through is >>1000× compared to rechargeable batteries.

In another embodiment, the inventive nano-device is a nano-battery comprising and NNN and an NMN. In this embodiment, the NNN may comprise nanoparticles, formed of cathode or cathode materials, such as a material selected from the group consisting of: Bismuth Trioxide, Cobalt Oxide Particles, Iron Disulfide, Lithium Aluminum Alloy, Lithium Carbonate, Lithium Cobalt Oxide (LCO), Lithium Cobalt Phosphate, Lithium Hydroxide, Lithium Hydroxide, Lithium Iron Phosphate (LFP), Lithium Iron(III) Oxide, Lithium Manganese Dioxide, Lithium Manganese Nickel Oxide (LMNO), Lithium Manganese Oxide (LMO), Lithium Molybdate, Lithium Nickel Cobalt Aluminum Oxide, Lithium Nickel Cobalt Oxide, Lithium Nickel Dioxide, Lithium Nickel Manganese Cobalt Oxide (NMC), Lithium Silicon Alloy, Lithium Tin Alloy, Lithium Titanate, Lithium Titanate Spinel, Manganese(IV) Oxide, Nickel Hydroxide, Silver Chromate, Silver Oxide, Vanadium Pentoxide. The NNN may also comprise nanowires that are metallized or non-metallized single/double (or more) stranded DNA (or other nucleotide analogue, such as PNA or the like), or other conductive or metallized polymers. The other network is an NMN, e.g., a mesh of interconnected carbon nanotubes, or other anode or cathode materials, acting as either the anode or cathode of the battery, such that when the NNN is a cathode, the NMN is an anode; and when the NNN is an anode, the NMN is a cathode.

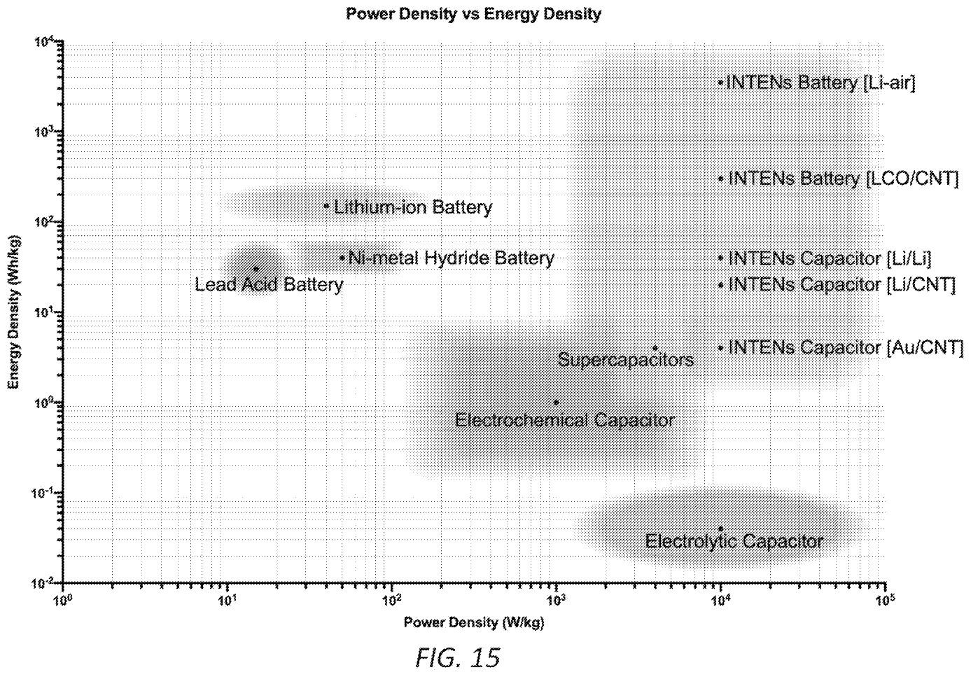

In particular embodiments, the inventive nano-devices can be selected from the group consisting of: Au/CNT Capacitors; Li/CNT Capacitors; Li ion/Li ion Capacitors; LCO (lithium cobalt oxide)/CNT Batteries; Li ion/Air Batteries, as set forth in FIG. 15.

Advantageously, this inventive nano-battery benefits from one or more of the following:
Significantly shortens the flow distance for ions.
Dramatically increases the surface area.
Dramatically increases the charging rate.
Dramatically reduces dendrite formation. One of the most important factors that leads to dendrite formation is the ion current density. The novel geometry of the disclosed battery increases the surface area and reduces the ion current density dramatically throughout the entire active medium. The ion current distribution becomes even compared to conventional geometry, in which there are hot spots with high ion current density that lead to dendritic growth.
Makes heat management more efficient as the ratio of surface area to volume increases significantly.
There are numerous paths for current and ions to flow. Thus, the disclosed battery is less prone to failures.
The active region is much more homogeneous than heterogeneous. As used herein “active region” corresponds to an area between the terminals.
Since the distance between anode and cathode pairs is much shorter, ionic conductivity is not a big issue.
One of the limitations of conventional geometry is the limited ion conductivity across the separator/active medium. On average, an ion diffuses for a distance of around 200 microns in conventional geometries. On the other hand, in the geometry of the disclosed battery, ions flow in a range of several tens of nanometers (e.g., 10 nm, 20 nm, 30 nm, 40 nm). This short diffusion distance leaves a lot of margin to tolerate low ionic conductivity. With the disclosed geometry, materials can be used that have as low as 1/10,000 ionic conductivity, if not lower.
Lithium air batteries can provide energy densities more than 10 times that of lithium-ion batteries. However, they are limited due to electroplating/dendritic growth and high rate of oxidation. The materials that would allow operation to some degree present extremely low ionic conductivities. On the other hand, due to the short distance of ion diffusion achieved by the disclosed geometry, extremely low ionic conductivity is not an issue. The disclosed geometry could make lithium-ion chemistry feasible/a reality for the first time. Thus, lithium ion batteries can provide more than 10-fold higher specific energy while being able to charge in a matter of seconds/sub-seconds.
Lithium metal battery chemistries increase energy density, but are also limited by electroplating/dendritic growth of lithium. In the disclosed battery, the reduction of ionic conductivity through the active medium and homogeneous ion current distribution enables such chemistries.

FIG. 14 illustrates an example of INTENS, according to an embodiment. As illustrated, nanoparticles 1411 are connected by DNA nanowires 1413 to form a network that makes electrical contact 1418 with a first terminal 1421. To form an inventive NMN, the carbon nanotubes 1414 are heaped or piled together between the terminals 1421 and 1422 to form a mesh (e.g., analogous to a pile of matchsticks). The mesh may be generalized as a porous structure (e.g., a structure with accessible, fillable, and/or contiguous empty volumes) with structural components capable of conducting electricity, being electrically charged, and/or accepting ions from the nanoparticles. Specifically, the carbon nanotubes, in some embodiments, cross each other at multiple locations, generating a continuous conductive mesh that makes electrical contact with the second (opposing) terminal 1422. Notably, the nanoparticle network (NNN) does not short with the carbon nanotube mesh (NMN), since the nanoparticles are coated with an insulating layer, and the DNA nanowires only conduct through the central axis while the phosphate backbone acts as an insulating layer 1416. In some embodiments, the insulating layer 1416 may include DNA nanowire material that attaches to the nanoparticle 1411 but does not attach to additional nanoparticles. In such embodiments, the insulating layer 1416 may be self-assembled during the self-assembly of the NNN.

In certain embodiments, the carbon nanotubes may have diameters in the range selected from the group consisting of: from about 0.1-1000 nm; 0.2-1000 nn; 0.3-1000 nm; 0.4-1000 nm; 0.5-1000; 0.6-1000 nm; 0.7-1000 nm; 0.8-1000 nm; 0.9-1000 nm; 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm. In other embodiments, the carbon nanotubes have diameters selected from no greater than: 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 25 nm, 20 nm, 15 nm, 10 nm, 9 nm, 8 nm, 7 nm, 6 nm, 5 nm, 4 nm, 3 nm, 2 nm or 1 nm, or the like.

In certain embodiments, the carbon nanotubes have lengths in the range selected from the group consisting of: 0.01-500 microns, 0.02-400 microns, 0.03-300 microns, 0.04-250 microns, 0.05-200 microns, 0.06-150 microns, 0.07-125 microns, 0.08-100 microns, 0.09-90 microns, 0.1-90 microns, 0.1-80 microns, 0.1-70 microns, 0.1-60 microns, 0.1-50 microns, 0.1-40 microns, 0.2-30 microns; 0.3-20 microns; 0.4-15 microns; 0.5-10 microns; 0.7-5 microns; 0.8-4 microns; 0.9-3 microns, 1-3 microns; and lengths of up to 1 or a few microns. In other embodiments, the carbon nanotubes have lengths selected from no greater than: 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 25 microns, 20 microns, 15 microns, 10 microns, 9 microns, 8 microns, 7 microns, 6 microns, 5 microns, 4 microns, 3 microns, 2 microns or 1 microns, or the like. In particular embodiments, the carbon nanotubes may have diameters in the range of 10 to 60 nanometers and lengths of up to 1 or a few microns.

In particular embodiments provided herein, the diameter of each of the nanoparticles may be in the range selected from the group consisting of: from about 0.1-1000 nm; 0.2-1000 nn; 0.3-1000 nm; 0.4-1000 nm; 0.5-1000; 0.6-1000 nm; 0.7-1000 nm; 0.8-1000 nm; 0.9-1000 nm; 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm. In other embodiments, the diameter of each of the nanoparticles is selected from the group consisting of no greater than: 900 nm; 800 nm, 700 nm, 600 nm, 500 nm, 450 nm, 400 nm, 350 nm, 300 nm, 275 nm, 250 nm, 225 nm, 200 nm, 175 nm, 150 nm, 125 nm, 100 nm, 90 nm, 80 nm, 70 nm, 60 nm, 50 nm, 45 nm, 40 nm, 35 nm, 30 nm 25 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm and no greater than 1 nm.

In a particular embodiment, the diameter of the nanoparticles is 20 to 60 nanometers.

In other embodiments, the total nano-device diameter is in the range selected from the group consisting of: from about 1 nm to about 900 nanometers; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; 20 nm to about 75 nm; from about 25 nm to about 50 nm.

In other embodiments, the total nano-device diameter is selected from the group consisting of no greater than: 900 nm; 800 nm, 700 nm, 600 nm, 500 nm, 450 nm, 400 nm, 350 nm, 300 nm, 275 nm, 250 nm, 225 nm, 200 nm, 175 nm, 150 nm, 125 nm, 100 nm, 90 nm, 80 nm, 70 nm, 60 nm, 50 nm, 45 nm, 40 nm, 35 nm, 30 nm 25 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm and no greater than 1 nm.

FIG. 15 illustrates a graph of power density versus energy density for various solutions, including different implementations of embodiments of the disclosed INTENS batteries and capacitors.

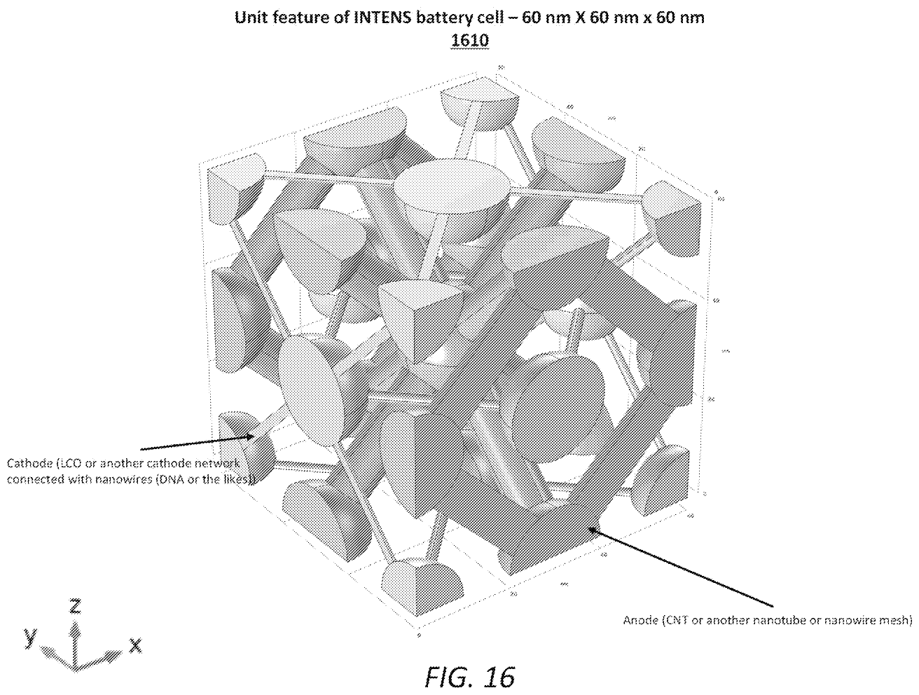

FIG. 16 is a diagram 1610 of a ‘unit’ cube of an embodiment of an INTENS structure. The unit cube, in some aspects, may be a cube that has a side length of 60 nm (double the distance between adjacent particles in different networks). The cathode may be any of the cathode materials discussed above. Additionally, the anode may be a carbon nanotube mesh or any of the other materials discussed above.

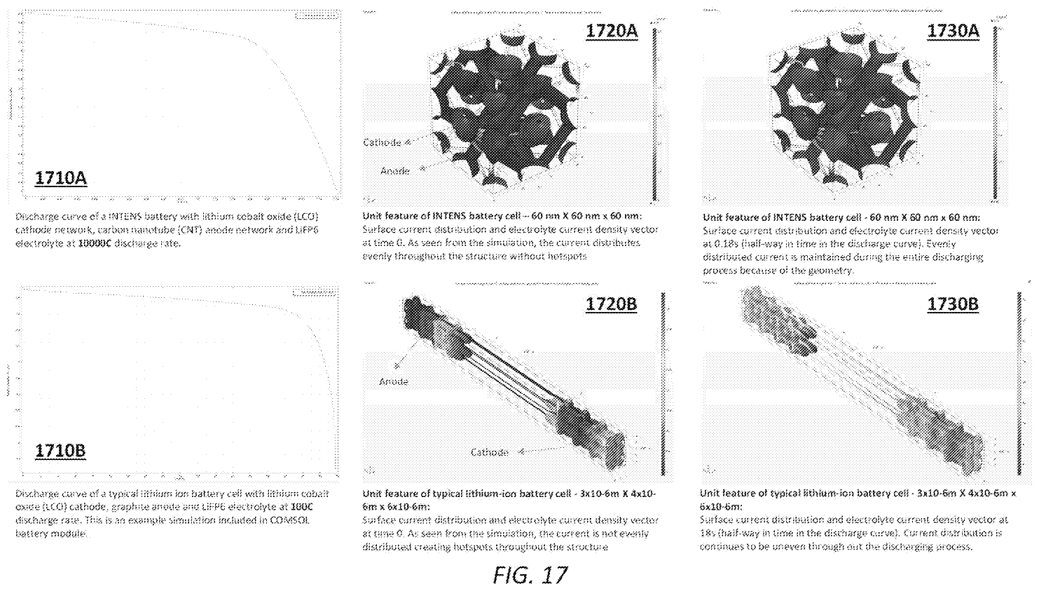

FIG. 17 is a set of diagrams comparing simulations of an INTENS battery to a simulation of a typical lithium-ion battery. Dendritic formation (e.g., catastrophic dendrite formation) often occurs around 6 mA/cm². In an INTENS battery, even at an extreme discharge rate such as 10000 C, electrolyte current density stays well below the dendritic threshold making charging/discharging in a fraction of a second a realistic possibility. On the other hand, in a conventional geometry, at a charging rate of 100 C, electrolyte current density significantly exceeds 6 mA/cm², making charging at this rate impossible without catastrophic dendrite formation.

Diagrams 1710A and 1710B compare a discharge curve (over a time of 0.36 seconds) of an INTENS battery at a discharge rate of 10000 C (1710A) and a discharge curve (over a time period of 36 seconds) of a typical lithium-ion battery at a discharge rate of 100 C (1710B). Diagrams 1720A and 1720B illustrate a simulation of a current density at a time 0 (a beginning of a discharge operation) for an INTENS battery and a typical lithium-ion battery, respectively. Diagrams 1720A and 1720B indicate that the current density range for the INTENS battery is 1-2.2 mA/cm² while the current density range for the typical lithium-ion battery may be between 9-13 mA/cm². Diagrams 1730A and 1730B illustrate a simulation of a current density at a time halfway through the discharge curve (e.g., 0.18 s or 18 s, respectively) for an INTENS battery and a typical lithium-ion battery, respectively. Diagrams 1730A and 1730B indicate that the current density range for the INTENS battery is 1-2.2 mA/cm² while the current density range for the typical lithium-ion battery may be between 6-22 mA/cm².

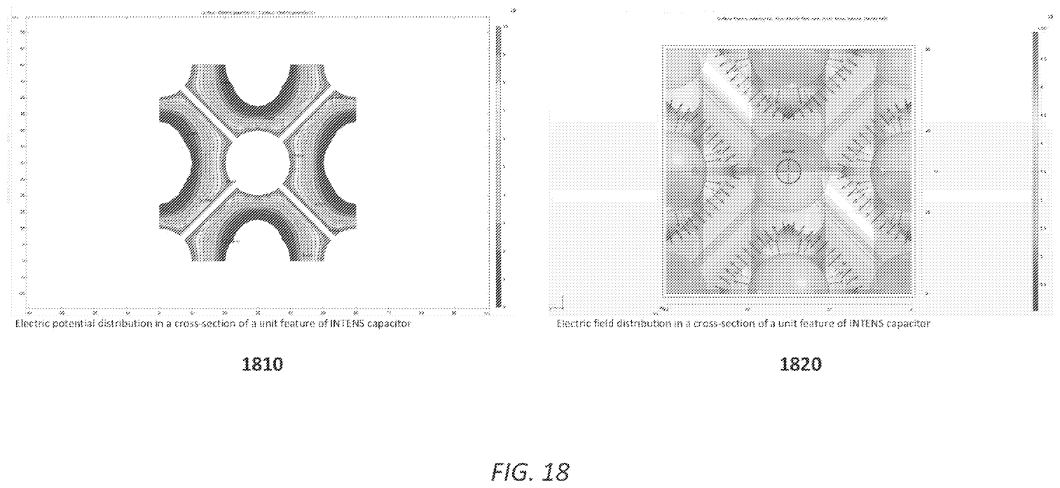

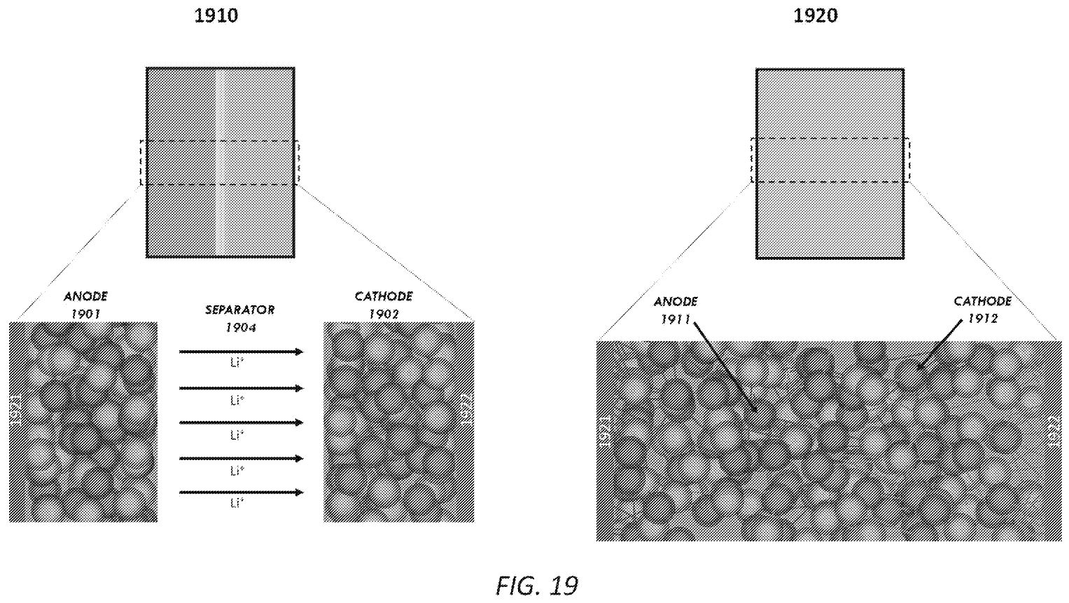

FIG. 18 includes a first diagram 1810 illustrating an electric potential distribution in a cross-section of a unit feature of an INTENS capacitor. FIG. 18 further includes a second diagram 1820 illustrating an electric field distribution in a cross-section of the unit feature of the INTENS capacitor. FIG. 19 includes a first diagram 1910 of a conventional battery structure and a second diagram 1920 of the inventive battery structure in accordance with some embodiments of the disclosure. As shown, the conventional battery structure depicted in diagram 1910, the anode material 1901 and the cathode material 1902 are bulk materials (˜200-500 micrometers thick) physically separated by a separator layer 1904 that may be tens to hundreds of micrometers thick while in the inventive battery structure depicted in diagram 1920 the anode material 1911 and the cathode material 1912 are interleaved, embedded, and/or interspersed with (or within) each other. This fundamental difference between the conventional battery structure and the inventive battery structure provides the benefits described above in relation to power density, energy density, charging rates, etc. while still providing the same external interface (e.g., terminal 1921 and 1922) for ease of adoption.

For example, the inventive battery structure illustrated in diagram 1920 may achieve the maximum theoretical surface area for ion diffusion, thus reducing the ion current density dramatically. Additionally, a lithium ion diffusion length may be reduced to less than 1/1000 compared to the conventional battery structure that, when combined with the optimized surface area, allows for rapid charge/recharge rates. Furthermore, the dramatic increase in surface area leads to superior heat management and safety and the structure is expected to be compatible to most current and future chemistries such as solid state, lithium-metal, lithium-air, or other chemistries that may be discovered.

In some embodiments, a composite device may include an active region (e.g., a region between terminals 421/422, 621/622, 821/822, 1321/1322, 1421/1422, and/or 1921/1922, or an active material). The material in the active region may be heterogeneous on a small scale while being homogeneous on a large scale. Small-scale heterogeneity is defined as having multiple types of components (e.g., two or more of an anodic material, a cathodic material, and/or a separator) in each, or a majority of, characteristic (cubic) volumes in the active region. The characteristic volume used to define the small-scale in some embodiments, may be cubic volumes having one of a side length of 1, 2, 3, 4, 5, 6, 7, 8, 9, 10, 20, 30, 40, 50, 60, 70. 80, 90, 100, 200, 300, 400, 500, 600, 700, 800, and/or 900 nm or one of a side length of 1, 2, 3, 4, 5, 6, 7, 8, 9, and/or 10 micrometers. In some embodiments, the active region may, conceptually, be divided into a plurality of contiguous (e.g., space filling) volumes when determining the homogeneity or heterogeneity of a device.

Large-scale homogeneity refers herein to having each, or a majority of, the characteristic (cubic) volumes in the active region including the same types of components (e.g., two or more of an anodic material, a cathodic material, and/or a separator). In some embodiments, the majority of characteristic volumes may include a majority that is greater than 50%, 60%, 70%, 80%, 90%, 95%, 96%, 97%, 98%, 99%, 99.1%, 99.2%, 99.3%, 99.4%, 99.5%, 99.6%, 99.7%, 99.8%, and/or 99.9%. Accordingly, the nano-device, in some embodiments, includes a large scale homogeneous active region with small-scale heterogeneity while a traditional device may include a large scale heterogeneous active region with small-scale homogeneity (e.g., where each, or a majority of, the characteristic volumes includes a single type of component, either an anodic material, a cathodic material, or a separator).

For example, referring to FIG. 19, within the bulk material of the conventional battery, a majority of a set of characteristic volumes within the anode material 1901 contains only anodic material, a majority of the set of characteristic volumes within the cathode material 1902 contains only cathodic material, and a majority of a set of characteristic volumes within the separator material 1904 contains only separator material. Accordingly, volumes throughout the active region are not homogeneous (e.g., are heterogeneous) on a large scale, but each of a majority of the volumes is internally homogeneous (e.g., homogeneous on a small scale). In some embodiments, the majority of characteristic volumes may include a majority that is greater than 50%, 60%, 70%, 80%, 90%, 95%, 96%, 97%, 98%, 99%, 99.1%, 99.2%, 99.3%, 99.4%, 99.5%, 99.6%, 99.7%, 99.8%, and/or 99.9%. However, throughout the active region of the inventive battery, a majority of the characteristic volumes may include all of anodic material 1911, cathodic material 1912, and separator material as described above, such that volumes throughout the active region are homogeneous compared to each other (e.g., on a large scale) while being internally heterogeneous.

In reference to some embodiments, As used herein, the term “homogeneous active region unit” refers to a unit of volume comprising a plurality of invention nano-devices described herein (e.g., a mesh of conductive nanowires in electrical contact; and a nanoparticle network embedded within the mesh of conductive nanowires, wherein the nanoparticle network comprises a plurality of nanoparticles in electrical contact) that is substantially constant and substantially the same and repeats within a specified larger area of volume or a cell within or between the terminals. In other words, regardless of where in the active region of the nanodevice (e.g,, nanobattery, nanocapacitor, and the like) a selected range of volumes of material is analyzed, or viewed at scale a specified volume of material (1 cubic micron, 10 cubic microns, 20, 30, 40, 50, 60, 70, 80, 90, 100, 125, 150, 175, 200 cubic microns, or the like), it will have all 3 components of that nanodevice, such as each of an anode, cathode and separator layer for a nanobattery; when multiple volumes are repeatedly analyzed within a cell. In other words, whatever volume is analyzed within the active region, it will have the same 3 components homogenously therein; whereas in prior art active regions (e.g., batter active regions), the anode, cathode and separator layer will not be homogenously present in all volumes analyzed above particular range, e.g., (1 cubic micron, 10 cubic microns, 20, 30, 40, 50, 60, 70, 80, 90, 100, 125, 150, 175, 200 cubic microns, or the like), This differs from prior art devices that are not homogeneous, but instead are heterogeneous because the will not likewise have all 3 components in the volume analyzed; and certainly in not a plurality of volumes analyzed within a single nanodevice cell. For example, within a single cell of an electronic device prior art batteries have at most 1 complete functioning anode/cathode and separator (lack of repeating battery unit); whereas in that exact same cell volume, the invention composite-nanobattery is comprised of numerous repeating complete battery units, e.g., comprising an anode, cathode and separator, selected from a repeating complete battery units corresponding to: at least 2, 10, 100, 1000, 10⁴, 10⁵, 10⁶, 10⁷, 10⁸, 10⁹, 10¹⁰, 10¹¹, 10¹², 10¹³, 10¹⁴, 10¹⁵, 10¹⁶, 10¹⁷, 10¹⁸, 10¹⁹, 10²⁰, and the like.

An important advantage provided by reducing the homogeneous active region unit down to, for example, 100 nm resolution, or lower is that the amount of surface area of the interface between the anode and cathode (e.g., the opposing charge regions creating the potential difference) is significantly and advantageously increased, as described herein. In other words, active region areas that were previously heterogenous, e.g., compartmentalized, have in accordance with the present invention, been converted to homogeneous regions (non-compartmentalized) down to a much lower resolution, (e.g., 1-100 nm, and the like) than prior art devices.

In other embodiments, the invention nano-device (e.g., nanobattery and nanocapacitor, and the like) materials are homogeneous within a single cell, whereas prior art devices are heterogeneous within a single cell down to the 1 micron, 900 nm, 800 nm, 700 nm, 600 nm, 500 nm, 400 nm, 300 nm, 200 nm, 100 nm, or lower.

As used herein, the term “heterogeneous” in the context of a complete nanodevice (e.g., nanobattery or nanocapacitor) unit refers to the lack of repeating complete electronic devices within that cell volume.

Provided herein is a nanodevice (e.g., composite-nanobattery, composite-nanocapacitor, and the like) comprising a plurality of nanodevices, wherein when viewed at a scale of 10⁶-10¹² nm³, is homogeneous. In other embodiments, scale viewed can range from 10²-10²⁰ nm³. In other embodiments, the scale viewed is selected from the group consisting of: 10², 10³, 10⁴, 10⁵, 10⁶, 10⁷, 10⁸, 10⁹, 10¹⁰, 10¹¹, 10¹², 10¹³, 10¹⁴, 10¹⁵, 10¹⁶, 10¹⁷, 10¹⁸, 10¹⁹, 10²⁰ nm³.

Likewise, for prior art batteries that have anode and cathode regions separated by a separator layer, the smallest unit volume that such prior art batteries can have (also referred to herein as a cell) is believed to be approximately equal to the 10 microns³ (e.g., 1,000 cubic microns).

### Example Use Cases

### Transport Energy Using Capacitors (or Stable Batteries)

Currently gasoline and oil is transported all over the world. It is converted into energy by the engines at the site of use. On the other hand, electrical energy cannot be transported for long distances. In that sense, it needs to be generated through thermoelectrical, hydroelectrical, atomic energy, wind energy etc. Most often these power stations are located very close to where they are utilized because of the loses in the energy transport through the grid (cite literature). Another big problem is the storage. Storing these types of energy is only possible for very short time. In particular rechargeable battery chemistries like lithium ion chemistries are not reliable storage systems despite their high specific energy.

For energy transport volumetric energy density is much more important compared to gravimetric energy density. For instance, the ships, trains and trucks can carry high weight loads for long distances, however their volume is limited. The key parameter to achieve transporting electrical energy is stability, namely not losing charge for a long time.

Capacitors are very stable. When you charge a capacitor and disconnect the electrodes it can hold charge as long as the material itself does not degrade. However, their gravitational and volumetric energy densities are very low making their use for long term energy store not feasible. Supercapacitors are better in terms of energy density making it closer to the battery chemistries, however, they suffer greatly from the stability. A modern supercapacitor loses about 20% of its charge. Therefore, they cannot be used for this purpose.

In accordance with the present invention, INTENS capacitors are at least comparable or exceed the energy density capability of the prior art batteries. The inventive capacitors stability is at least comparable to typical capacitors while their energy density gravimetric or volumetric would be at least comparable to the modern rechargeable battery chemistries. INTENS capacitors can be used to transport electrical energy over long distances, including across the globe. The inventive capacitors can be used to store electrical energy for a longer time even up to several years or more. This way electrical energy can be generated using various power stations including thermal, solar, hydroelectric, nuclear, wind at the sites where such means of energy generation is feasible. Then, this energy can be used to charge INTENS capacitors (or batteries although INTENS batteries are much more stable than typical rechargeable batteries, INTENS capacitors are still much more stable). Later these INTENS capacitors can be loaded on ships, trains, trucks to be transported some other part of the world. For instance, one can imagine a high surface area and low cost land like a desert like the Sahara Desert to be covered with solar cell farms and the produced energy can be transported to places that consumes a lot of energy but limited sun exposure like New York City.

Thus, methods of transporting electrical energy across large geographic distances are provided herein, comprising generating electrical energy; storing the electric energy in an inventive INTENS capacitor or INTENS battery; and delivering said electrical energy to and end-user. The distance travelled for the delivery of the electric energy is selected from greater than: 50 mi, 75 mi, 100, mi, 150 mi, 200 mi, 250 mi, 300 mi, 350 mi, 400 mi, 450 mi, 500 mi, 600 mi, 700 mi, 800 mi, 900 mi, 1000 mi, 1250 mi, 1500 mi, 1750 mi, 2000 mi, 2500 mi, 3000 mi. 3500 mi, 4000 mi, 4500 mi. or 5000 mi, or more.

### Inductive Charging

As the charging rate increases dramatically, alternative ways are contemplated here in accordance with the present inventive of charging in addition to conventional rates as the bottle neck becomes supplying the power to the energy storage device, capacitor or battery. This is important because in most cases the charging rates can be quicker than plugging in the charging cord to charge the device. For example, in order to handle hard currents, much thicker charging cords are contemplated for use herein, which might make manual charging less practical. For such embodiments, it is contemplated herein to utilize automated systems and/or electrodes having a higher surface area to reduce the current density. The larger electrode surface area reduces current density, which thus helps materials withstand high total currents. In particular embodiments, electrodes with high surface areas are provided herein.

However, as the charging rates increases power applied by the charger/charging station is so high that in particular for applications requiring large batteries such as electrical vehicles to pull that much power from the grid becomes problematic. As the charge discharge rate increases it is reflected on the power density. Typically, the power density of INTENS devices are relatively high (see FIG. 15). In particular, the bottle neck is not the battery or the capacitor anymore; but rather the limitation is the power source itself. For these applications, it is contemplated herein to use an INTENS battery/capacitor. In these particular applications and/or embodiments, an inventive INTENS device can be charged prior to engagement with the battery/capacitor to be charged at a slower pace compatible with the capabilities of the grid. For example, an electric vehicle (EV) can engage with an already sufficiently charged charging station and once the engagement of EV is completed with the charging station, the energy transfer can be handled through inductive charging via “high surface area electrodes” that can withstand high current energy transfer.

As used herein, the phrase “high surface area electrodes” refers to any surface area that can withstand high current energy transfer. Exemplary high surface area electrodes include, for example, the entire under-carriage, frame, roof, and/or body of any vehicle; a large portion or the entire portion (all) of the back surface of a phone, and the like.

In another implementation, while an EV moving on the freeway, there can be sections with inductive coils to wirelessly charge the cars passing through them. This coils could be periodically distributed through a particular lane. As hyper-fast energy transfer is required, these coils could be connected to a INTENS capacitor/battery, which is charged prior to the EV passing through it in a rate that the grid can handle. Having these coils connected to INTENS battery/capacitor distributed throughout the lane would ensure that the EV would be charged by a charged INTENS capacitor/battery that is in sufficiently charged state.

The inventive devices and methods are contemplated herein to advantageously change the operation of EVs. For example, current EVs are charged over a relatively long period of time; e.g., mostly overnight when they are parked. When they run out of battery they have to be charged in a charging station in a relatively long amount time. With the hyper-fast highway/freeway charging contemplated herein, the EV will be kept charged on the freeway and may not need to be ever need to drive by to a charging station.

Another convenient location for hyper-fast charging contemplated herein are traffic lights. When a car is waiting on the traffic light, it could stop on top of a coil. Considering most traffic lights stay at red in the range of minutes, it might be sufficient to charge an INTENS battery/capacitor at a slower pace much slower than their maximum charging rate. This will permit pulling the current directly from the grid and transferring via a coil wirelessly rather than charging a INTENS battery/capacitor prior to the engagement localized in the ground. If there are several traffic lights in the route, the EV does not need to be charged fully in each stop; it can be partially be charged at different stops.

Alternatively, there can be electrodes lifting up and touching the electrodes at a convenient location in the car such as the bottom undercarriage of the car. When a car stops over the zone, the sensors could detect the presence of the car and lift up the electrodes of the charging station to charge the EV with contact. This can be applied to wireless charging as well as the proximity improves the efficiency of the energy transfer. The automated lifts can bring up to coils to the close proximity of the coils of the EV to achieve energy transfer.

Other than, EVs hyper-fast charging would provide different implementations for other electronics such as smart phones. As hyper-fast charging can be achieved in a very short time frame around a fraction of seconds (microseconds, milliseconds, seconds, etc), one can utilize hyper-fast charging surfaces in places like malls. Instead of plugging cables into the phone. Phones can be touched to a surface briefly to be charged.

For drones for various different applications, there can be landing zones for drones to briefly land on to be charged to go on their way. This would be very useful for drones that are used for delivery applications.

As the charging becomes much faster, it is contemplated herein to accelerate the monetary transfer for using such charging stations. RFID, Bluetooth based smart systems can be implemented assigning vehicles/devices a unique code for the monetary exchange via automated app/software with only very limited effort on the customer side.

What is claimed is:

1. A nano-device comprising:
a mesh of conductive nanostructures in electrical contact; and
a nanoparticle network embedded within the mesh of conductive nanostructures, wherein the nanoparticle network comprises a plurality of nanoparticles in electrical contact.

2. The nano-device of claim 1, wherein the conductive nanostructures comprise carbon nanotubes and the nanoparticle network further comprises a plurality of nanowires to form a nanoparticle-nanowire-network (NNN), wherein the NNN provides the electrical contact between the plurality of nanoparticles.

3. The nano-device of claim 2, wherein each of the plurality of nanoparticles is coated with an insulating layer, and wherein each nanowire of the plurality of nanowires comprises a phosphate backbone that insulates a central axis of the nanowire.

4. The nano-device of claim 1, further comprising a first terminal and a second terminal.

5. The nano-device of claim 4, wherein the mesh and the nanoparticle network are positioned between the first terminal and the second terminal.

6. The nano-device of claim 4, wherein first terminal and the second terminal are on a same side of the nano-device.

7. The nano-device of claim 1, wherein the nano-device is a battery.

8. The nano-device of claim 1, wherein the nano-device is a capacitor.

9. The nano-device of claim 3, wherein the nanoparticle network is electrically connected to the first terminal by a set of nanowires in the nanoparticle network.

10. The nano-device of claim 3, wherein the mesh is electrically connected to the second terminal by a subset of the nanostructures.

11. The nano-device of claim 3, wherein the conductive nanostructures are selected from carbon nanotubes or silicon-based nanowires.

12. The nano-device of claim 2, wherein each of the plurality of nanoparticles is coated with an insulating layer, and wherein each nanowire of the plurality of nanowires comprises a phosphate backbone that insulates a central axis of the nanowire.

13. The nano-device of claim 1, wherein each of the nanostructures has a diameter in a range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the nanostructures have diameters selected from no greater than: 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 25 nm, 20 nm, 15 nm, 10 nm, 9 nm, 8 nm, 7 nm, 6 nm, 5 nm, 4 nm, 3 nm, 2 nm or 1 nm.

14. The nano-device of claim 1, wherein each of the nanostructures has a length in a range selected from the group consisting of between: 0.01-500 microns, 0.02-400 microns, 0.03-300 microns, 0.04-250 microns, 0.05-200 microns, 0.06-150 microns, 0.07-125 microns, 0.08-100 microns, 0.09-90 microns, 0.1-90 microns, 0.1-80 microns, 0.1-70 microns, 0.1-60 microns, 0.1-50 microns, 0.1-40 microns, 0.2-30 microns; 0.3-20 microns; 0.4-15 microns; 0.5-10 microns; 0.7-5 microns; 0.8-4 microns; 0.9-3 microns, 1-3 microns; or the nanostructures have lengths selected from no greater than: 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 25 microns, 20 microns, 15 microns, 10 microns, 9 microns, 8 microns, 7 microns, 6 microns, 5 microns, 4 microns, 3 microns, 2 microns or 1 microns.

15. The nano-device of claim 1, wherein each of the plurality of nanoparticles has a diameter may be in a range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the diameter of each of the nanoparticles is selected from the group consisting of no greater than: 900 nm; 800 nm, 700 nm, 600 nm, 500 nm, 450 nm, 400 nm, 350 nm, 300 nm, 275 nm, 250 nm, 225 nm, 200 nm, 175 nm, 150 nm, 125 nm, 100 nm, 90 nm, 80 nm, 70 nm, 60 nm, 50 nm, 45 nm, 40 nm, 35 nm, 30 nm 25 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, 2 nm and no greater than 1 nm.

16.-47. (canceled)

48. A conductive-nanostructure-mesh-network (CNMN), comprising: a plurality of conductive nanostructures capable of conducting or storing a charge, wherein substantially all of the plurality of nanostructures are in direct contact with two or more nanostructures of the plurality of nanostructures forming a continuous CNMN.

49. The CNMN of claim 48, wherein the CNMN is electrically connected to a first terminal by a subset of the nanostructures.

50. The CNMN of claim 48, wherein the conductive nanostructures are selected from carbon nanotubes or silicon-based nanowires.

51. The CNMN of claim 48, wherein each of the plurality of conductive nanostructures has a diameter in a range selected from the group consisting of: from about 0.1-1000 nm; 0.2-1000 nm; 0.3-1000 nm; 0.4-1000 nm; 0.5-1000; 0.6-1000 nm; 0.7-1000 nm; 0.8-1000 nm; 0.9-1000 nm; 1 nm to about 900 nm; from about 2 nm to about 500 nm; from about 3 nm to about 300 nm; from about 4 nm to about 200 nm; from about 5 to about 150 nm; from about 10 to about 150; from about 15 nm to about 150 nm; from about 15 nm to about 100 nm; from about 20 nm to about 75 nm; from about 10 to about 60 nm; from about 0.5 to about 60 nm; and from about 25 nm to about 50 nm; or the nanostructures have diameters selected from no greater than: 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 25 nm, 20 nm, 15 nm, 10 nm, 9 nm, 8 nm, 7 nm, 6 nm, 5 nm, 4 nm, 3 nm, 2 nm or 1 nm.

52. The CNMN of claim 48, wherein each of the plurality of nanostructures has a length in a range selected from the group consisting of between: 0.01-500 microns, 0.02-400 microns, 0.03-300 microns, 0.04-250 microns, 0.05-200 microns, 0.06-150 microns, 0.07-125 microns, 0.08-100 microns, 0.09-90 microns, 0.1-90 microns, 0.1-80 microns, 0.1-70 microns, 0.1-60 microns, 0.1-50 microns, 0.1-40 microns, 0.2-30 microns; 0.3-20 microns; 0.4-15 microns; 0.5-10 microns; 0.7-5 microns; 0.8-4 microns; 0.9-3 microns, 1-3 microns; or the nanostructures have lengths selected from no greater than: 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 25 microns, 20 microns, 15 microns, 10 microns, 9 microns, 8 microns, 7 microns, 6 microns, 5 microns, 4 microns, 3 microns, 2 microns or 1 microns.
